(19) United States
(12) Patent Application Publication
(10) Pub. No.: US 2025/0085303 A1
(43) Pub. Date: Mar. 13, 2025

(54) ROBOTIC PLATFORM FOR AUTOMATED REAL-TIME HIGH THROUGH-PUT OPTOGENETICS TESTING

(71) Applicant: Wisconsin Alumni Research Foundation, Madison, WI (US)

(72) Inventors: Megan McClean, Fitchburg, WI (US); Zachary Harmer, Madison, WI (US)

(21) Appl. No.: 18/825,498

(22) Filed: Sep. 5, 2024

Related U.S. Application Data
(60) Provisional application No. 63/580,605, filed on Sep. 5, 2023.

(51) Int. Cl. G01N 35/00; B01L 3/00; G01N 21/13

(52) U.S. Cl. CPC G01N 35/0099; B01L 3/50853; G01N 21/13; B01L 2300/0654; B01L 2400/0433

(57) ABSTRACT

The present disclosure provides systems and methods for performing optogenetics experiments. The system of the present disclosure is an automated optogenetics system, comprising: an illumination element configured to apply an illumination program to at least one discrete region of a cell container; a shaker element configured to shake the cell container; a detector element, configured for measuring at least one of optical density, bioluminescence, fluorescence, and absorbance from the at least one discrete region; and optionally, a transfer element configured to transfer the cell container, during an experiment, between any two or more of the illumination element, the shaker element, and the detector element.

### CROSS-REFERENCE TO RELATED APPLICATIONS

The present application claims priority to and the benefit of U.S. Provisional Patent Application No. 63/580,605, “Robotic Platform For Automated Real-time High-throughput Optogenetics Testing” (filed Sep. 5, 2023). All foregoing applications are incorporated herein by reference in their entireties for any and all purposes.

### GOVERNMENT RIGHTS

This invention was made with government support under GM128873 awarded by the National Institutes of Health. The government has certain rights in the invention.

### SEQUENCE LISTING

The instant application contains a Sequence Listing which is being submitted herewith electronically in XML format and is hereby incorporated by reference in its entirety. Said XML copy, created on Oct. 16, 2024, is named 04144000280_Sequence listing_SL.xml and is 43000 bytes in size.

### TECHNICAL FIELD

The present invention relates to the field of optogenetics and laboratory automation including robotics.

### BACKGROUND

Optogenetics is the use of light to control cellular behavior and processes. Light is a useful inducer for controlling biological systems because it can be precisely added or removed in a temporally- and spatially controlled manner. This precise control of light is useful for optimizing bioproduction processes, designing engineered living materials, and interrogating native cell signaling pathways.

In particular, optogenetics allows for dynamic, spatial, and temporal control over cellular behavior using light. Optogenetics leverages light-sensitive proteins, taking advantage of light responsive changes in protein conformation to actuate processes inside the cell. Such tools have been used to activate specific signaling pathways, repress and activate transcription, control protein localization, and induce protein degradation.

One example approach is to control a process of interest by fusing effectors to light-activated hetero- or homodimerizers to generate activity through proximity. For example, light-sensitive split transcription factors (TFs) are frequently generated by fusing one protein of an optical heterodimerizer pair to a DNA-binding domain (DBD) and the other to an activation domain (AD). This allows expression of the gene of interest (GOI) to be activated by inducing dimerization (and reconstitution) of the split TF using light.

One of the challenges of using optogenetics is that prototyping a construct for a given application and identifying appropriate illumination conditions both represent significant bottlenecks. To generate a functional optogenetic construct, many factors need to be tuned and tested including expression levels, linker lengths, and choice of components. Once constructs are created, a high-throughput method is needed to characterize their function and activity in response to light. Bioreactor-based techniques have been developed that allow real-time measurement of light-sensitive cultures, but they have limited throughput. Several tools allow for individual programming of LEDs in a microwell plate format and enable higher throughput light-stimulation. Further, these approaches still lack a method for high-throughput and rapid measurement of the optogenetic system response. The recent optoPlateReader partially solves this problem but requires the use of many biological replicates to obtain reliable data and lacks access to liquid handling capabilities, important for performing certain assays or long-term experiments.

Accordingly, there is a need in the art for developing a system that enables high through-put testing with regular output measurements that also allows for longer term experiments. The present disclosure addresses this need.

### SUMMARY

In meeting the described long-felt needs, the present disclosure first provides an automated optogenetics system, comprising: an illumination element configured to apply an illumination program to at least one discrete region of a cell container; a shaker element configured to shake the cell container; a detector element, configured for measuring at least one of optical density, bioluminescence, fluorescence, and absorbance from the at least one discrete region; and optionally, a transfer element configured to transfer the cell container, during an experiment, between any two or more of the illumination elements, the shaker element, and the detector element.

The present disclosure also provides a process for performing optogenetics, comprising: placing a cell container loaded with one or more biological samples onto a shaker element; performing a shaking program on the cell container with the shaker element; illuminating, in accordance with an illumination program, one or more discrete regions of the cell container; and detecting, using a detector element, one or more signals associated with one or more discrete regions of the sample plate.

Also provided is a method for selecting an illumination program, comprising: a) applying a first illumination program to a biological sample, the first illumination program comprising a first combination of one or more light intensities, one or more light duty cycles, one or more light pulse durations, and one or more light pulse frequencies; b) detecting one or more signals from the biological sample; c) determining, from the one or more detected signals, an activation state of one or more biological pathways of the biological sample; d) based on the detected signal, (i) continuing to apply the first illumination program to the biological sample for a duration of time or (ii) applying a second illumination program to the biological sample; and e) repeating steps b) to d) until a selected activation state of the biological sample is obtained.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 depicts an exemplary automated platform as contemplated by the present disclosure. The robotic gripper arm can transfer microwell plates between the illumination device, shaking device, and plate reader.

FIG. 2 depicts an exemplary illumination, shake, measure cycle of the optogenetics automated platform provided by the present disclosure.

FIG. 3 depicts exemplary experimental results from and optogenetics experiment with optogenetic split transcription factor (TF) with CRY2 and CIB1 as the optical dimerizer pair. When Gal4AD is recruited to Gal4DBD (bound to pGAL1), expression of the gene of interest (mScarlet) is induced, shown in the schematic in the left panel. mScarlet fluorescence driven by induction of the CRY2 PHR/CIB1 TF (p=0.000039, t-statistic=160, paired Student's t-test), with non-fluorescent (negative) cells, a non-inducing control with only the reporter construct, and mScarlet under constitutive (pRPL18B) expression is shown in the right panel. Measurements were taken every 30 minutes and raw fluorescence values are shown for the light and dark conditions 10 hours into induction.

FIG. 4 depicts a diagram illustrating multiplexing. In the provided example, one inducer can be used to send more signals through the same channel (light). One channel (light), can send different signals to activate different outputs in biological activity, including, for example, induction of targeted gene expression.

FIG. 5 depicts a schematic of an LED array applied to a sample plate for performing high-throughput light induction using the system of the present disclosure.

FIG. 6A is a line graph showing induction of a CRY2(535)/CIB1 split TF strain over time by light regimes with constant on times and varied off times in the left panel. Each intermediate induction regime shown has a 5-minute pulse of light followed by an interval of darkness as indicated on the figure legend for the duration of light induction (shown on the horizontal axis). The red vertical line indicates when the cultures reach saturation (FIG. 11).

FIG. 6B is a graph showing decay of mRuby2 photoactivation effect. The dots are averages of triplicate measurements (arranged by the time since removal of light induction, shown on the horizontal axis) collated from the plots shown in FIG. 8A. The line shows the exponential decay curve fit to the data.

FIG. 7A depicts a schematic using the yeast optogenetic toolkit, multigene cassettes containing optical dimerizers fused to appropriate effector domains and controlled by a range of promoter strengths are created and integrated into the yeast genome. Once expressed, the light-inducible split TF induces expression of the fluorescent reporter, pGAL1-mScarlet, in a light-dependent manner.

FIG. 7B depicts a scatterplot where each dot represents the fold change in mScarlet fluorescence between light and dark conditions for a different transformant of the eMagA/eMagB split TF. Data shown represent averaged triplicates measured after 12 hours of light induction.

FIG. 7C depicts a heat map showing fold change in fluorescence after 12 hours of induction between light and dark conditions for eMagA/eMagB split TF strains with components expressed at different levels. Horizontal and vertical axes identify the strains with each split TF component under low (pRPL18B), medium (pHHF1), or high (pTEF1) expression.

FIG. 7D depicts fluorescence values after 12 hours of light induction at the indicated light intensities for strains expressing split TFs using the indicated protein pairs and a reporter-only pGal1-mScarlet control strain.

FIG. 8A depicts a table showing the mutations made to design eMagBM (encircled by a dashed line). Mutation of residue 74 to I was associated with slower kinetics in pMag.

FIG. 8B depicts a bar graph of fluorescence values shown after 12 hours of continuous light induction between light and dark samples of strains with eMagB- or eMagBM-based split TFs. Fluorescence with the eMagA/eMagB split TF system increases 3.4-fold under light induction and fluorescence of the eMagA/eMagBM split TF system increases 10.8-fold. All split TF components are expressed under pRPL18B.

FIG. 8C depicts line graphs where fluorescence is shown for the eMagA/eMagBM TF strain under different induction regimes that vary the pulse on and pulse off times in minutes and seconds. The vertical red line shows when the cultures reach saturation, and the horizontal axis shows time since the start of induction.

FIG. 9 depicts an exemplary 96-well plate layout. Light conditions are checkerboarded (light gray wells correspond to light induction, and dark gray wells correspond to dark treatment). Dotted lines indicate groupings of triplicate samples (with light and dark conditions) for each strain.

FIG. 10A depicts a diagram showing growth in continuously shaking conditions relative to intermittent shaking measured using OD700. The lag was measured at OD700=0.7 based on the sensitivity analysis in FIG. 10B. Lag time is measured by subtracting the time needed for constantly shaking samples to reach certain OD700 values from the time needed for intermittently shaking samples to reach the same density. Measurements are taken every 30 minutes, and values are interpolated by linear approximation between measurements.

FIG. 10B depicts sensitivity analysis of lag time to reach certain OD700 values between intermittent and constant shaking conditions for non-fluorescent (negative), eMagA/eMagB, and reporter-only (pRPL18B-mScarlet) strains. Lag is constant between OD700 of 0.6 and 0.8, therefore we quantified lag at OD700=0.7 for each strain (non-fluorescent: 0.67 hours, eMagA/eMagB: 1.18 hours, pRPL18B-mScarlet: 1.02 hours).

FIG. 11 depicts a graph showing OD700 values for the CRY2(535)/CIB1 split TF strain used in FIG. 6A. The vertical red line indicates when the cultures reach saturation. There were no significant differences in OD700 between cultures exposed to different light induction programs.

FIG. 12A depicts data showing photoactivation of the pRPL18B-mRuby2 strain. Lengths of light induction are shown in the legend; time since beginning light induction is shown on the horizontal axis.

FIG. 12B depicts induction of a non-fluorescent control strain (negative) and the pRPL18B-mRuby2 strain (constitutive) after 12 hours. The photoactivated mRuby2 strain shows significantly higher fluorescence than the dark control (Student's t-test; t-statistic: 11.77, p-value: 0.007).

FIG. 12C depicts decay of the mRuby2 photoactivation effect. The dots are averages of triplicate measurements (arranged by time since removal of light induction, shown on the horizontal axis) collated from the plots shown in FIG. 12B. The line shows the exponential decay curve fit to the data.

FIG. 13 depicts a dot plot showing fluorescence fold-change between light and dark conditions for various construct transformants after 12 hours of light induction. L/M/H designations indicate whether each split TF component is under low (pRPL18B), medium (pHIF1), or high (pTEF1) expression.

FIG. 14A depicts heat map showing fold change in fluorescence after 12 hours of induction between light and dark conditions for eMagA/eMagBM split TF strains with components expressed at different levels. Horizontal and vertical axes identify the strains with each split TF component under low (pRPL18B), medium (pHHF1), or high (pTEF1) expression. Compare to eMagA/eMagB strains in FIG. 7C.

FIG. 14B depicts OD700 values for the eMagA/eMagBM split TF strain used in FIG. 8C. The vertical red line indicates when the cultures reach saturation. There were no significant differences in OD700 between cultures exposed to different light induction programs.

FIG. 15 depicts an exemplary method of performing an optogenetics experiment using the system as contemplated by the present disclosure.

FIG. 16 depicts an exemplary method for selecting an illumination program as contemplated by the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

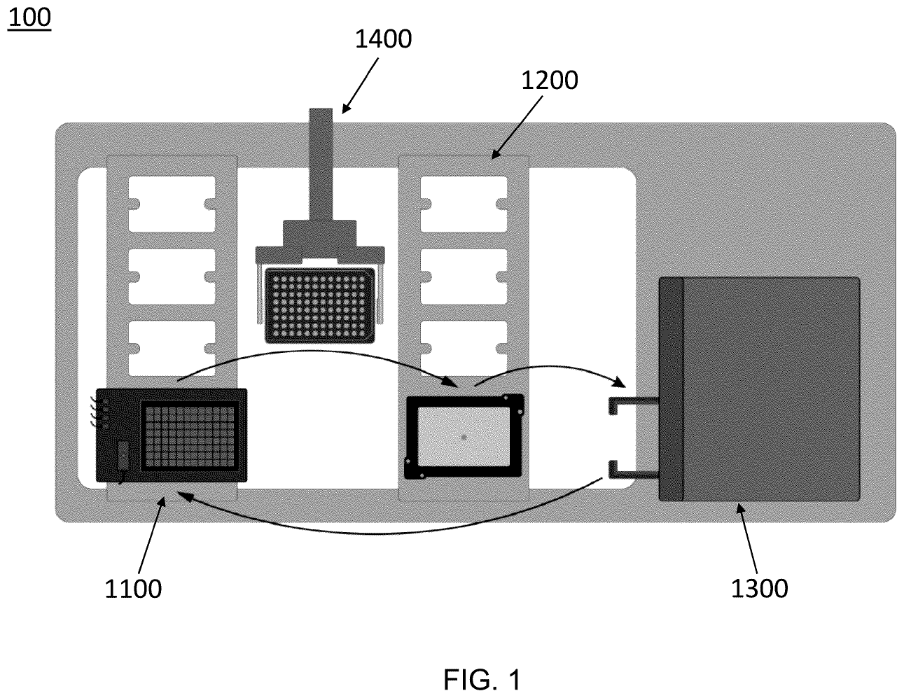

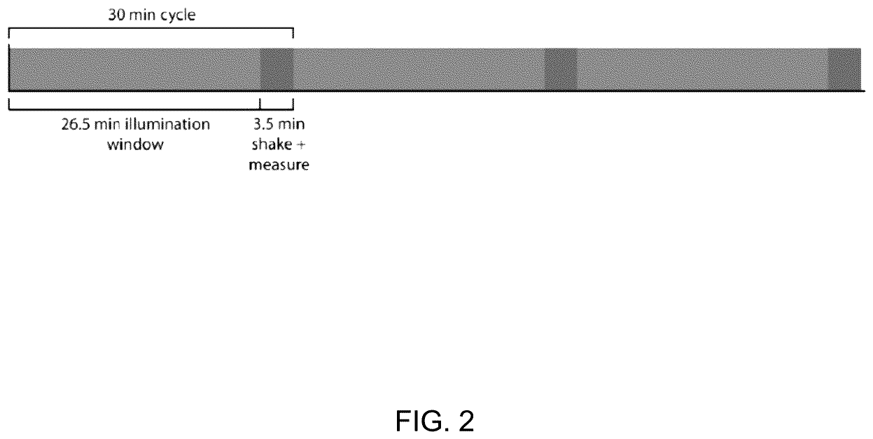

The present disclosure provides an automated optogenetics system for conducting optogenetics experiments in a high-throughput manner with the ability to perform longitudinal experiments with longer term timepoints than current systems allow. As shown in FIG. 1, an automated optogenetic system 100 according to the present disclosure includes an illumination element 1100, a shaker element 1200, and a detector element 1300. In some embodiments, the automated optogenetic system can also include a transfer element 1400.

The illumination element 1100 can be configured to apply an illumination program to at least one discrete region of a cell container. The cell container can include any suitable cell culture container as understood in the art including for example a multi-well plate. The multi-well plate can include a 6-well plate, a 12-well plate, a 24-well plate, a 48-well plate, a 96-well plate, and the like. The multi-well plate can include a black-walled multi-well plate. The multi-well plate can include a glass-bottomed multi-well plate. The multi-well plate can include, for example a multi-well plate suitable for imaging using one or more optical techniques including for example light microscopy.

In some embodiments, the illumination program can include one or more light intensities, one or more light duty cycles, one or more light pulse durations, one or more light pulse frequencies, and/or one or more combinations thereof. The illumination program can include one or more on/off sequences of illumination. The one or more on/off sequences can include illumination at one or more intensities of light, one or more wavelengths of light, and/or one or more combinations thereof.

The one or more intensities of light can include an intensity of from about 0.1 μW/cm² to about 200 μW/cm². That is, the intensity of light can include from about 0.1 μW/cm² to about 1 μW/cm², from about 1 μW/cm² to about 5 μW/cm², from about 5 μW/cm² to about 10 μW/cm², from about 10 μW/cm² to about 20 μW/cm², from about 20 μW/cm² to about 30 μW/cm², from about 30 μW/cm² to about 40 μW/cm², from about 40 μW/cm² to about 50 μW/cm², from about 50 μW/cm² to about 75 μW/cm², from about 75 μW/cm² to about 100 μW/cm², from about 100 μW/cm² to about 125 μW/cm², from about 125 μW/cm² to about 150 μW/cm², from about 150 μW/cm² to about 175 μW/cm², from about 175 μW/cm² to about 200 μW/cm², including any and all increments therebetween.

The one or more light duty cycles can include from about 5% to about 100%. The one or more light duty cycles can include from about 5% to about 10%, from about 10% to about 15%, from about 15% to about 20%, from about 20% to about 25%, from about 25% to about 30%, from about 30% to about 40%, from about 40% to about 50%, from about 50% to about 60%, from about 60% to about 70%, from about 70% to about 80%, from about 80% to about 90%, from about 90% to about 100%, including any and all increments therebetween.

The one or more light pulse durations can include from about 0.5 second to about 120 seconds. In some embodiments, the at least one light pulse duration can include from about 1 minute to about 240 minutes. The one or more light pulse durations can include from about 1 minute to about 5 minutes, from about 5 minutes to about 10 minutes, from about 10 minutes to about 20 minutes from about 20 minutes to about 40 minutes, from about 40 minutes to about 60 minutes, from about 60 minutes to about 90 minutes, from about 90 minutes to about 120 minutes, from about 120 minutes to about 150 minutes, from about 150 minutes to about 180 minutes, from about 180 minutes to about 210 minutes, from about 210 minutes to about 240 minutes, from about 240 minutes to about 270 minutes, from about 270 minutes to about 300 minutes, including any and all increments and/or combination of increments therebetween. In some embodiments, the at least one light pulse duration can include from about 1 minute to about 96 hours. The one or more light pulse durations can include from about 1 minute to about 30 minutes, from about 30 minutes to about 1 hour, from about 1 hour to about 2 hours, from about 2 hours to about 4 hours, from about 4 hours to about 8 hours, from about 8 hours to about 12 hours, from about 12 hours to about 18 hours, from about 18 hours to about 24 hours, from about 24 hours to about 36 hours, from about 36 hours to about 48 hours, from about 48 hours to about 60 hours, from about 60 hours to about 72 hours, from about 72 hours to about 96 hours, including any and all increments therebetween.

The one or more light pulse frequencies can include from about 0.5 Hz to about 5 Hz. The one or more light pulse frequencies can include from about 0.5 Hz to about 1 Hz, from about 1 Hz to about 1.5 Hz, from about 1.5 Hz to about 2 Hz, from about 2 Hz to about 2.5 Hz, from about 2.5 Hz to about 3 Hz, from about 3 Hz to about 3.5 Hz, from about 3.5 Hz to about 4 Hz, from about 4 Hz to about 4.5 Hz, from about 4.5 Hz to about 5 Hz, from about 5 Hz to about 5.5 Hz, from about 5.5 Hz to about 6 Hz, from about 6 Hz to about 6.5 Hz, from about 6.5 Hz to about 7 Hz, from about 7 Hz to about 7.5 Hz, from about 7.5 Hz to about 8 Hz, from about 8 Hz to about 8.5 Hz, from about 8.5 Hz to about 9 Hz, from about 9 Hz to about 9.5 Hz, from about 9.5 Hz to about 10 Hz, including any and all increments therebetween.

The one or more wavelengths of light can include one or more wavelengths in the visible light range of the electromagnetic spectrum. For example, the one or more wavelengths can include one or more wavelengths in the range of from about 380 nm to about 700 nm, including one or more combinations of discrete wavelengths in the visible light range. The one or more wavelengths can include one or more wavelengths in the near infrared range of the electromagnetic spectrum. For example, the one or more wavelengths can include one or more wavelengths in the range of from about 750 nm to about 900 nm, including one or more combinations of discrete wavelengths in the near infrared range of wavelengths. The one or more wavelengths can include one or more wavelengths in the ultraviolet range of wavelengths. For example, the one or more wavelengths can include one or more wavelengths in the range of from about 100 nm to about 380 nm, including one or more combinations of discrete wavelengths in the ultraviolet range of wavelengths. The one or more wavelengths can include one or more combinations of wavelengths in the range of from about 100 nm to about 900 nm.

In some embodiments, the illumination element is configured to apply a first illumination program to a first discrete region of the cell container and a second illumination program to a second discrete region of the cell container, the first illumination program and the second illumination program differing from one another.

The shaker element 1200 can be configured to shake the cell container in a suitable manner for maintaining a culture of cells, including for example, nonadherent cells.

The shaker element can be adjusted to shake at a suitable shaking speed. The shaking speed can include up to 200 rpm, from about 200 rpm to about 300 rpm, from about 300 rpm to about 400 rpm, from about 400 rpm to about 500 rpm, from about 500 rpm to about 600 rpm, from about 600 rpm to about 700 rpm, from about 700 rpm to about 800 rpm, from about 800 rpm to about 900 rpm, from about 900 rpm to about 1000 rpm, from about 1000 rpm to about 1200 rpm, from about 1200 rpm to about 1400 rpm, from about 1400 rpm to about 1600 rpm, from about 1600 rpm to about 1800 rpm, from about 1800 rpm to about 2000 rpm, from about 2000 rpm to about 2200 rpm, from about 2200 rpm to about 2400 rpm, from about 2400 rpm to about 2600 rpm, from about 2600 rpm to about 2800 rpm, from about 2800 rpm to about 3000 rpm, including any and all increments therebetween. In some embodiments, the shaking speed is about 1000 rpm.

The shaker element can be programed to shake the cell container at one or more speeds over the course of an experiment. In some embodiments, the shaker element can be programmed to shake the cell container at a single speed. The shaker element can shake the cell container for a duration of time including up to about 5 seconds, from about 5 seconds to about 10 seconds, from about 10 seconds to about 20 seconds, from about 20 seconds to about 30 seconds, from about 30 seconds to about 1 minute, from about 1 minute to about 2 minutes, from about 2 minutes to about 3 minutes, from about 3 minutes to about 4 minutes, from about 4 minutes to about 5 minutes, from about 5 minutes to about 6 minutes, from about 6 minutes to about 7 minutes, from about 7 minutes to about 8 minutes, from about 8 minutes to about 9 minutes, from about 9 minutes to about 10 minutes, including any and all increments therebetween. In some embodiments, the shaker element can shake the cell container for about 1 minute.

In some embodiments, the shaker element can be programmed to shake the cell container at a first speed for a first duration of time, and then changed to a second speed for a second duration of time. In some embodiments, the shaker element can be programmed to shake the cell container at two or more speeds for a particular duration of time. In some embodiments, the shaker can be programmed to shake the cell container at a first speed, for example during a growth stage suitable for the cells in the container for a growth stage of the experiment, and then changed to a second speed for a maintenance stage of the experiment.

The shaker element can include a temperature controller configured to maintain a temperature of the cell container while the cell container is associated with the shaker element. The temperature controller can be adjusted to a suitable temperature for maintaining cells. In some embodiments, the temperature controller can be adjusted to an ambient temperature including from about 20° C. to about 25° C., including for example about 23° C. The temperature controller can be adjusted to a temperature in the range of from about 10° C. to about 15° C., from about 15° C. to about 20° C., from about 20° C. to about 25° C., from about 25° C. to about 30° C., from about 30° C. to about 35° C., from about 35° C. to about 40° C., from about 40° C. to about 45° C., from about 45° C. to about 50° C., from about 50° C. to about 55° C., from about 55° C. to about 60° C., from about 60° C. to about 65° C., from about 65° C. to about 70° C., from about 70° C. to about 75° C., from about 75° C. to about 80° C., from about 80° C. to about 85° C., from about 85° C. to about 90° C., from about 90° C. to about 95° C., from about 95° C. to about 100° C., including any and all increments therebetween. For example, in some embodiments, the temperature controller is adjusted to about 37° C. The temperature controller can be programmed to maintain a first temperature for a first duration of time, and then adjust the temperature to a second temperature for a second duration of time, and so on. The first, second or subsequent durations of time for the temperature controller can include up to about 30 seconds, from about 30 seconds to about 1 minute, from about 1 minute to about 2 minutes, from about 2 minutes to about 3 minutes, from about 3 minutes to about 4 minutes, from about 4 minutes to about 5 minutes, from about 5 minutes to about 6 minutes, from about 6 minutes to about 7 minutes, from about 7 minutes to about 8 minutes, from about 8 minutes to about 9 minutes, from about 9 minutes to about 10 minutes, from about 10 minutes to about 15 minutes, from about 15 minutes to about 20 minutes, from about 20 minutes to about 25 minutes, from about 25 minutes to about 30 minutes, from about 30 minutes to about 35 minutes, from about 35 minutes to about 40 minutes, from about 40 minutes to about 45 minutes, from about 45 minutes to about 50 minutes, from about 50 minutes to about 55 minutes, from about 55 minutes to about 60 minutes, from about 1 hour to about 1.5 hours, from about 1.5 hours to about 2 hours, from about 2 hours to about 4 hours, from about 4 hours to about 6 hours, from about 6 hours to about 8 hours, from about 8 hours to about 10 hours, from about 10 hours to about 12 hours, from about 12 hours to about 18 hours, from about 18 hours to about 24 hours, from about 24 hours to about 36 hours, and/or from about 36 hours to about 48 hours, including any and all increments therebetween.

The detector element 1300 can be configured for measuring at least one signal from at least one discrete region of the cell container. The discrete region can include, for example, a single well of a cell container including, for example a 96-well plate. The discrete region can include one or more wells of a cell container. For example, the discrete region can include 2 wells, 3 wells, 4 wells 5 wells, 6 wells, 7 wells, 8 wells, 9 wells, 10 wells, 12 wells, and so on, or one or more portion or combination thereof of a 96-well plate. The discrete region can include one or more rows of wells and/or one or more columns of wells of a cell container including, for example a 96-well plate. The discrete region can include a single well of a cell containing including, for example a 24-well plate. For example, the discrete region can include 2 wells, 3 wells, 4 wells, 5 wells, 6 wells, and so on, or one or more portions or combinations thereof, of a 24-well plate. The discrete region can include one or more rows of wells, and/or one or more columns of wells of a 24-well plate.

The at least one measured signal can include one or more of an optical density signal, a bioluminescence signal, a fluorescence signal, an absorbance signal, and/or one or more combinations thereof. The detector element 1300 can be configured to measure the signal from the at least one discrete region. The system 100 can be configured to measure the at least one signal from the discrete region at one or more time points during an experiment.

The system 100 can include a transfer element 1400 configured to transfer the cell container, during an experiment, between any two or more of the illumination element, the shaker element, and the detector element. For example, the transfer element can include a gripper arm element. The transfer element can be controlled remotely, programmed to operate autonomously, or a combination thereof.

In some embodiments, the automated optogenetic system 100 can include one or more fluid handling elements 1500 (not shown). The fluid handling element 1500 can be configured to collect a fluid sample from the at least one discrete region of the cell container following application of an illumination program to the at least one discrete region of the cell container. The fluid handling element 1500 can be configured to collect a fluid from the at least once discrete region of the cell container at one or more timepoints following application of an illumination program, at one or more timepoints prior to application of an illumination program, and/or a combination thereof. The collected fluid can be assayed using a detector configured to measure one or more of absorbance, optical density, bioluminescence, and fluorescence.

In some embodiments, the fluid handling element 1500 is configured to deposit a fluid sample into at least one discrete region of the cell container. The deposited fluid can include, for example, a volume of cell culture media, one or more buffers, one or more reagents for detecting one or more signals including for example, an absorbance, an optical density, a bioluminescence, a fluorescence. The deposited fluid can include one or more reagents for performing one or more assays including for example an absorbance assay, an optical density assay, a bioluminescence assay, a fluorescence assay, or one or more combinations thereof. The cell culture media can include any suitable media for culturing the contained cells including for example complete media such as synthetic complete media. The one or more buffers can include one or more of phosphate buffered saline, Hanks' buffered saline, RNeasy Lysis Buffer, Reporter Lysis Buffer, luciferase lysis buffer, passive lysis buffer, luciferin, coelenterazine, water and the like. The one or more reagents for detecting a signal or performing an assay can include one or more substrates, colorimetric reagents, and the like.

### Methods

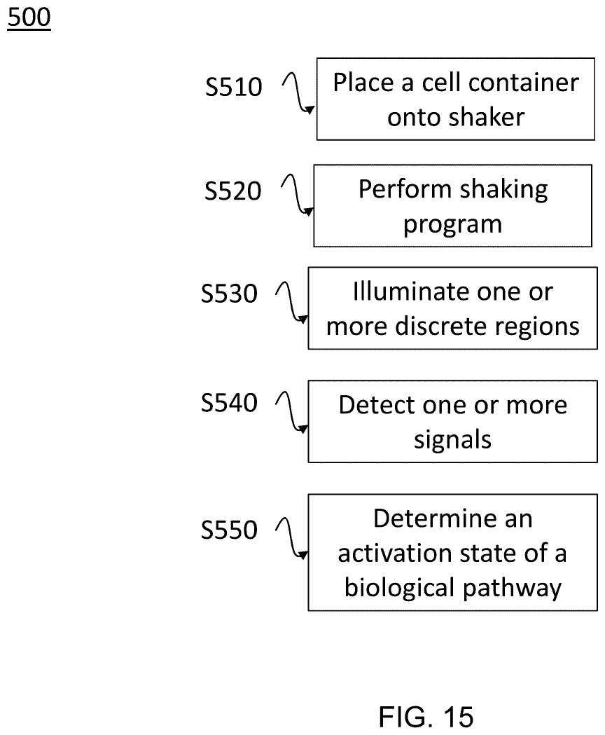

Referring now to FIG. 15, embodiments of the present invention provide a process or methods 500 for performing optogenetics. A process according to the present disclosure can include a step S510 of placing a cell container loaded with one or more biological samples onto a shaker element. The one or more biological samples can include one or more samples of non-adherent cells including, for example, yeast cells, one or more samples of adherent cells, and/or one or more combinations thereof.

The method or process 500 can include a step S520 of performing a shaking program on the cell container with the shaker element. The shaking program can include one or more steps of shaking the cell container at one or more speeds for one or more durations of time. The one or more speeds can include one or more of up to 100 rpm, from about 100 rpm to about 200 rpm, from about 200 rpm to about 300 rpm, from about 300 rpm to about 400 rpm, from about 400 rpm to about 500 rpm, from about 500 rpm to about 600 rpm, from about 600 rpm to about 700 rpm, from about 700 rpm to about 800 rpm, from about 800 rpm to about 900 rpm, from about 900 rpm to about 1000 rpm, form about 1000 rpm to about 1200 rpm, from about 1200 rpm to about 1400 rpm, from about 1400 rpm to about 1600 rpm, from about 1600 rpm to about 1800 rpm, from about 1800 rpm to about 2000 rpm from about 2000 rpm to about 2500 rpm, from about 2500 rpm to about 3000 rpm, from about 3000 rpm to about 3500 rpm, from about 3500 rpm to about 4000 rpm, from about 4000 rpm to about 4500 rpm, from about 4500 rpm to about 5000 rpm, and so one, including any and all increments therebetween. The one or more durations of time can include up to about 30 seconds, from about 30 seconds to about 1 minute, from about 1 minute to about 2 minutes, from about 2 minutes to about 3 minutes, from about 3 minutes to about 4 minutes, from about 4 minutes to about 5 minutes, from about 5 minutes to about 10 minutes, from about 10 minutes to about 15 minutes, from 15 minutes to about 20 minutes, from about 20 minutes to about 30 minutes, from about 30 minutes to about 45 minutes, from about 45 minutes to about 60 minutes, from about 1 hour to about 2 hours, from about 2 hours to about 4 hours, from about 4 hours to about 6 hours, from about 6 hours to about 8 hours, from about 8 hours to about 10 hours, from about 10 hours to about 12 hours, from about 12 hours to about 18 hours, from about 18 hours to about 24 hours, from about 24 hours to about 48 hours, and so on, including any and all increments therebetween.

Embodiments of the methods or process 500 can include a step S530 of illuminating, in accordance with an illumination program, one or more discrete regions of the cell container. The illumination program can include applying an illumination program to at least one discrete region of a cell container. The cell container can include any suitable cell culture container as understood in the art including, for example, a multi-well plate. The multi-well plate can include a 6-well plate, a 12-well plate, a 24-well plate, a 48-well plate, a 96-well plate, and the like. The multi-well plate can include a black-walled multi-well plate. The multi-well plate can include a glass-bottomed multi-well plate. The multi-well plate can include, for example a multi-well plate suitable for imaging using one or more optical techniques including for example light microscopy.

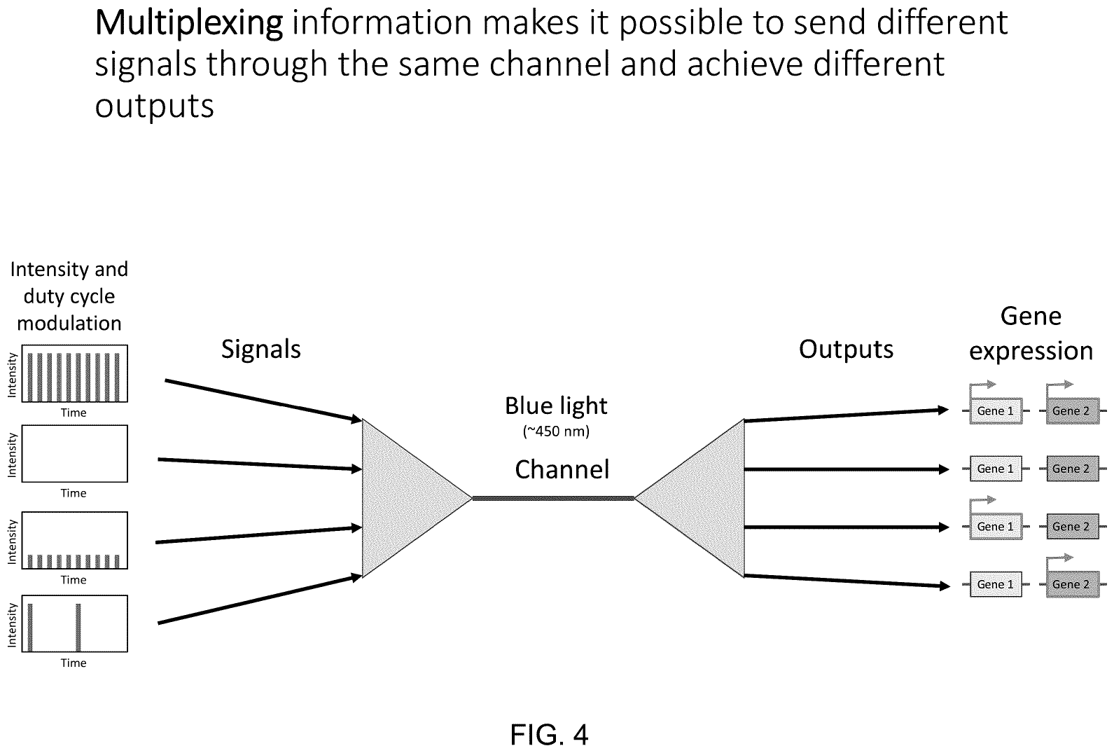

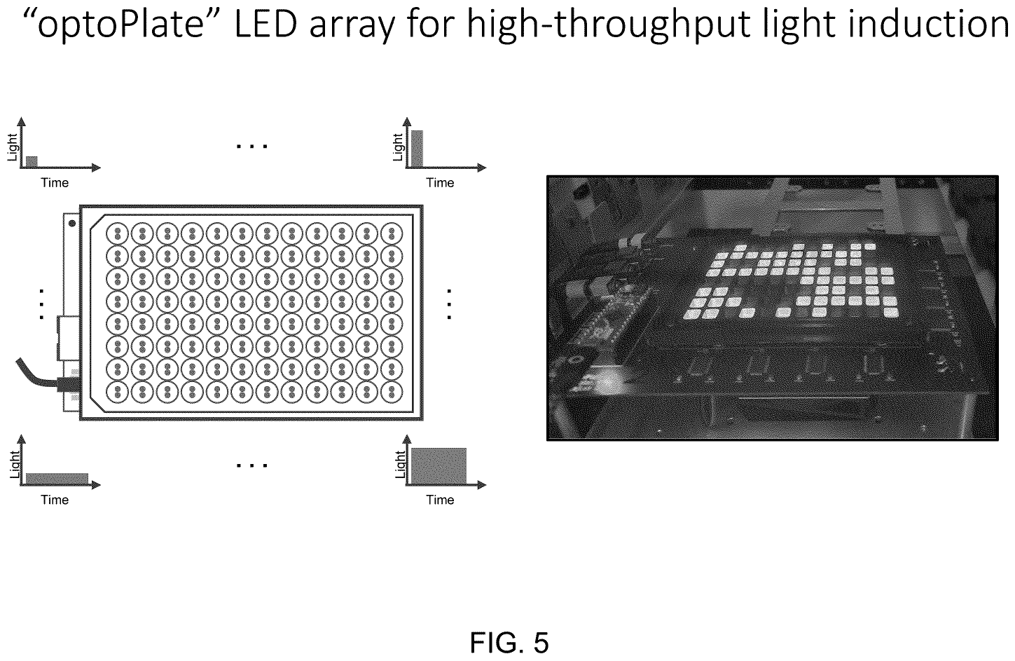

In some embodiments, the illumination program can include one or more light intensities, one or more light duty cycles, one or more light pulse durations, one or more light pulse frequencies, and/or one or more combinations thereof. In some embodiments, the illumination program can include one or more on/off sequences of illumination. For example, the illumination program can include multiplexing one or more on/off sequences of illumination, as shown in FIG. 4. The one or more on/off sequences can include illumination at one or more intensities of light, one or more wavelengths of light, and/or one or more combinations thereof.

Embodiments of the process 500 can include a step S540 of detecting, using a detector element, one or more signals associated with one or more discrete regions of the sample plate. In some embodiments, the detecting is performed intermittently over a time course. The detecting can include measuring at least one signal from at least one discrete region of the cell container. The discrete region can include, for example, a single well of a cell container including, for example a 96-well plate. The discrete region can include one or more wells of a cell container. For example, the discrete region can include 2 wells, 3 wells, 4 wells, 5 wells, 6 wells, 7 wells, 8 wells, 9 wells, 10 wells, 12 wells, and so on, or one or more portion or combination thereof of a 96-well plate. The discrete region can include one or more rows of wells and/or one or more columns of wells of a cell container including, for example a 96-well plate. The discrete region can include a single well of a cell containing including, for example a 24-well plate. For example, the discrete region can include 2 wells, 3 wells, 4 wells, 5 wells, 6 wells, and so on, or one or more portions or combinations thereof of a 24-well plate. The discrete region can include one or more rows of wells, and/or one or more columns of wells of a 24-well plate.

The detecting can include detecting at least one measured signal. The at least one measured signal can include one or more of an optical density signal, a bioluminescence signal, a fluorescence signal, an absorbance signal, and/or one or more combinations thereof. The detector element 1300 can be configured to measure the signal from the at least one discrete region. The system 100 can be configured to measure the at least one signal from the discrete region at one or more time points during an experiment.

Embodiments of the process or methods 500 can include a step S550 of determining, based on the detected signal, an activation state of one or more biological pathways of the biological sample. In some embodiments, the activation state comprises at least one of an elevated or increased expression of one or more proteins, modulation of one or more ion channels, and/or modulation of one or more signaling pathways relative to a comparator control. In some embodiments, the one or more biological pathways comprise one or more light-sensitive cellular pathways.

Embodiments of the process or methods 500 can include a step S560 of collecting a fluid sample from the one or more discrete regions of the cell container following application of the illumination program to the one or more discrete regions of the cell container. In some embodiments, the collected fluid is assayed using a detector configured to measure one or more of absorbance, optical density, bioluminescence, and fluorescence.

Embodiments of the process or methods 500 can include a step S570 of depositing a fluid sample into one or more discrete regions of the cell container. The deposited fluid can include, for example, one or more buffers, one or more cell culture media, one or more reagents including assay reagents, and the like, including one or more combinations thereof.

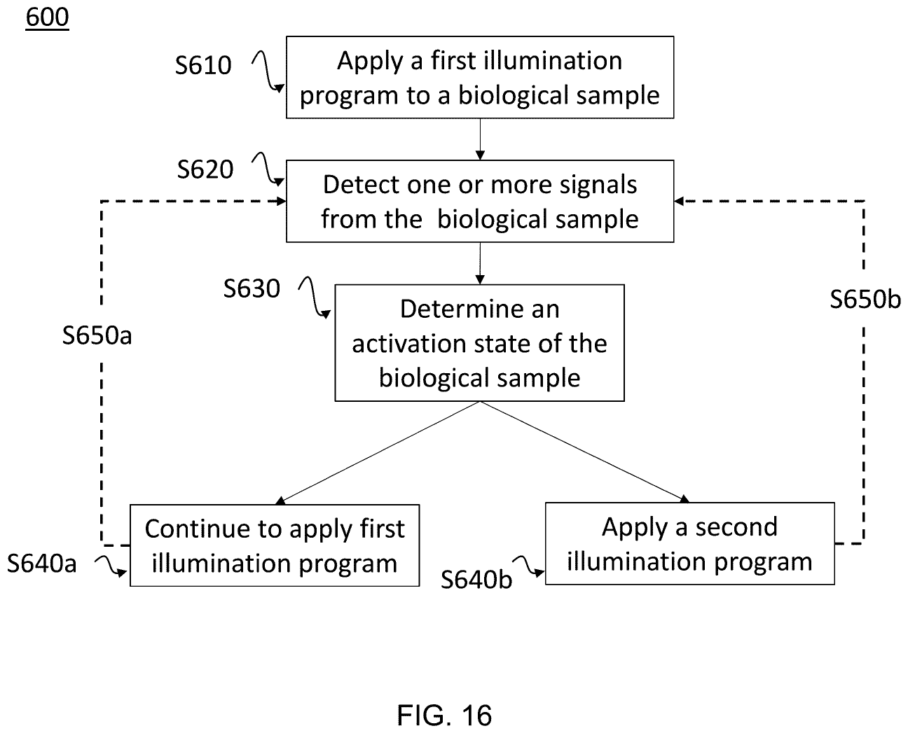

Referring now to FIG. 16, embodiments of the present disclosure provide a method 600 for selecting an illumination program. The method 600 can include a step S610 of applying a first illumination program to a biological sample, the first illumination program comprising a first combination of one or more light intensities, one or more light duty cycles, one or more light pulse durations, and one or more light pulse frequencies. In some embodiments, the one or more light intensities comprise from about 0.1 μW/cm² to about 200 μW/cm².

The one or more intensities of light can include an intensity of from about 0.1 μW/cm² to about 200 μW/cm². That is, the intensity of light can include from about 0.1 μW/cm² to about 1 μW/cm², from about 1 μW/cm² to about 5 μW/cm², from about 5 μW/cm² to about 10 μW/cm², from about 10 μW/cm² to about 20 μW/cm², from about 20 μW/cm² to about 30 μW/cm², from about 30 μW/cm² to about 40 μW/cm², from about 40 μW/cm² to about 50 μW/cm², from about 50 μW/cm² to about 75 μW/cm², from about 75 μW/cm² to about 100 μW/cm², from about 100 μW/cm² to about 125 μW/cm², from about 125 μW/cm² to about 150 μW/cm², from about 150 μW/cm² to about 175 μW/cm², from about 175 μW/cm² to about 200 μW/cm², including any and all increments therebetween.

In some embodiments, the at least one light pulse duration is from about 0.5 second to about 120 seconds. In some embodiments, the at least one light pulse duration is from about 1 minute to about 240 minutes. The one or more light pulse durations can include from about 1 minute to about 5 minutes, from about 5 minutes to about 10 minutes, from about 10 minutes to about 20 minutes from about 20 minutes to about 40 minutes, from about 40 minutes to about 60 minutes, from about 60 minutes to about 90 minutes, from about 90 minutes to about 120 minutes, from about 120 minutes to about 150 minutes, from about 150 minutes to about 180 minutes, from about 180 minutes to about 210 minutes, from about 210 minutes to about 240 minutes, from about 240 minutes to about 270 minutes, from about 270 minutes to about 300 minutes, including any and all increments and/or combination of increments therebetween.

In some embodiments, the at least one light duty cycle is from about 5% to about 100%. The one or more light duty cycles can include from about 5% to about 10%, from about 10% to about 15%, from about 15% to about 20%, from about 20% to about 25%, from about 25% to about 30%, from about 30% to about 40%, from about 40% to about 50%, from about 50% to about 60%, from about 60% to about 70%, from about 70% to about 80%, from about 80% to about 90%, from about 90% to about 100%, including any and all increments therebetween.

In some embodiments, the at least one light pulse frequency is from about 0.5 Hz to about 5 Hz. The one or more light pulse frequencies can include from about 0.5 Hz to about 1 Hz, from about 1 Hz to about 1.5 Hz, from about 1.5 Hz to about 2 Hz, from about 2 Hz to about 2.5 Hz, from about 2.5 Hz to about 3 Hz, from about 3 Hz to about 3.5 Hz, from about 3.5 Hz to about 4 Hz, from about 4 Hz to about 4.5 Hz, from about 4.5 Hz to about 5 Hz, from about 5 Hz to about 5.5 Hz, from about 5.5 Hz to about 6 Hz, from about 6 Hz to about 6.5 Hz, from about 6.5 Hz to about 7 Hz, from about 7 Hz to about 7.5 Hz, from about 7.5 Hz to about 8 Hz, from about 8 Hz to about 8.5 Hz, from about 8.5 Hz to about 9 Hz, from about 9 Hz to about 9.5 Hz, from about 9.5 Hz to about 10 Hz, including any and all increments therebetween.

The method 600 can include a step S620 of detecting one or more signals from the biological sample. In some embodiments, a detected signal comprises one or more of an optical density, an absorbance, a bioluminescence, a fluorescence, or a combination thereof.

The method 600 can include a step S630 of determining, from the one or more detected signals, an activation state of one or more biological pathways of the biological sample. The activation state can include expression or detection of one or more proteins or genes, for example, relative to a comparator control. The activation state can include a detected upregulation of one or more proteins or genes, for example, relative to a comparator control. The activation state can include detection of one or more post-translational modifications including for example a phosphorylation of one or more residues on one or more proteins.

The method 600 can include a step S640 of based on the detected signal, a step S640a continuing to apply the first illumination program to the biological sample for a duration of time or a step S640b applying a second illumination program to the biological sample. In some embodiments, the first illumination program and the second illumination program differ in terms of one or more of a light intensity, a light duty cycle, a pulse duration, a light pulse periodicity, and a light pulse frequency.

The method 600 can include a step S650 of repeating steps S620 to S640 until a selected activation state of the biological sample is obtained. In some embodiments, the biological sample comprises one or more of yeast cells, bacterial cells, and mammalian cells. The biological sample can include cells that include non-adherent cells. The biological sample can include cells that include adherent cells.

In some embodiments, the selected activation state is defined by one or more detected signal values associated with the selected activation state. The one or more detected signal values can include one or more of an expression level of one or more biological signaling readouts including, for example, one or more detected gene expression levels, protein expression levels, protein activation or protein activation levels, and the like. The detected signal value can include, for example, a detected absolute value and/or a detected value relative to a comparator control. The detected signal value can include a detected upregulation of one or more proteins or genes, for example, relative to a comparator control. The detected signal value can include detection of one or more post-translational modifications including, for example, a phosphorylation of one or more amino acid residues on one or more proteins.

In some embodiments, the selected activation state can be defined by one or more characteristics of a fluid collected from the biological sample. The one or more characteristics of the collected fluid can include any one or more of a pH value, a concentration of one or more solutes in the biological sample, and/or one or more combinations thereof.

### EXAMPLES

The following Examples are provided to illustrate some of the concepts described within this disclosure. Although the Examples are provided to present illustrative, non-limiting embodiments, the Examples also should not be considered to limit the more general embodiments described herein or the scope of any appended claims.

### Example 1—Integration of Laboratory Automation and Light Stimulation for High-Throughput Optogenetics

In order to increase testing throughput and reliability of optogenetics experiments, an automated platform of the present disclosure, referred to herein as Lustro, was developed for screening and characterizing optogenetic systems. Lustro comprises an illumination device, a shaking device, and a plate reader integrated into a Tecan Fluent Automated Workstation (FIG. 1).

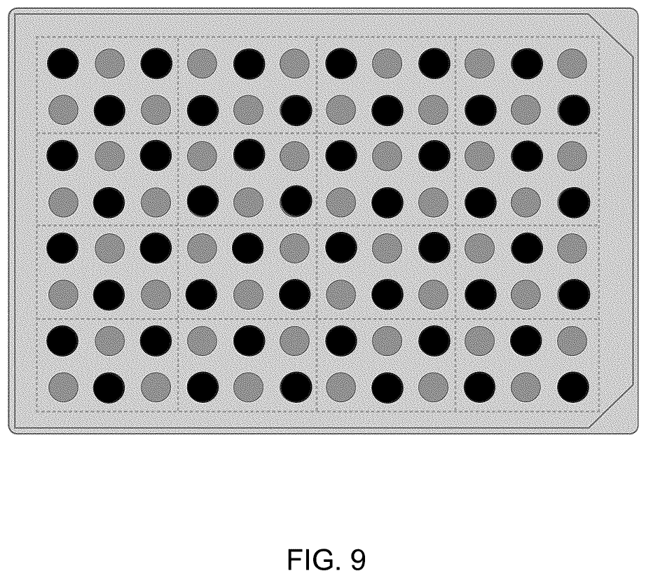

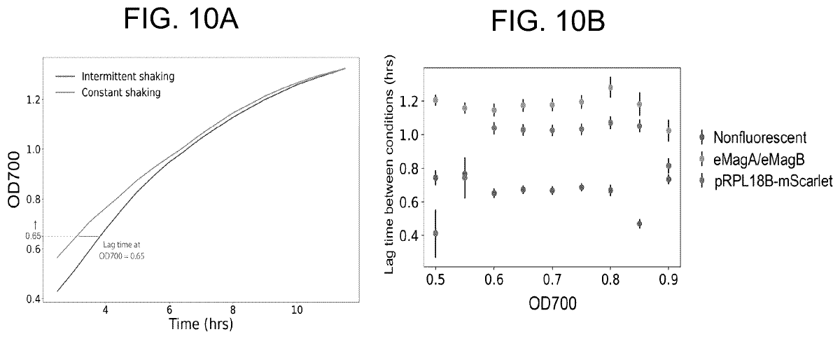

A Robotic Gripper Arm (RGA) is able to move a microwell plate between these devices according to a programmed schedule. Cultures of S. cerevisiae were diluted into a 96-well plate with conditions measured in triplicate (FIG. 9). This plate was placed on the illumination device (an optoPlate) for 26.5 minutes to receive light induction by individually programmable LEDs. The RGA then moved the plate to the shaking device to shake at 1000 rpm for 60 seconds to resuspend the yeast cells. This ensures accurate and consistent measurements of a homogenous culture and improves growth conditions. The plate was then moved to the plate reader to measure optical density and fluorescence before being moved back to the illumination device. The cycle was repeated in 30-minute intervals. Due to its size and weight, the optoPlate could not be incorporated onto the small plate shaker. Therefore, the cells were shaken intermittently, which led to a small but measurable lag in growth (FIGS. 10A and 10B).

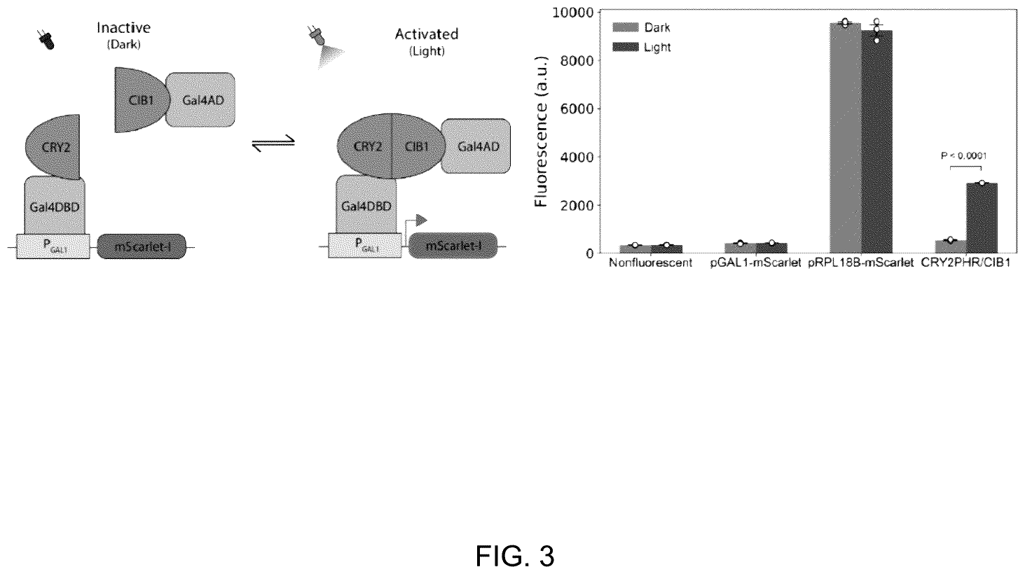

It was demonstrated that the Lustro platform can be used to measure the activity of optogenetic split TFs (FIG. 3). These split TFs utilize the Gal4 DNA-binding domain (Gal4DBD) and Gal4 activation domain (Gal4AD) to drive expression of the fluorescent reporter mScarlet-I31 (hereafter referred to as mScarlet) from the pGAL1 promoter under light induction. This signal was readily measured by the plate reader. A strain carrying a split transcription factor based on an optogenetic heterodimerizer pair (the cryptochrome CRY2 PHR and its binding partner CIB119) (FIG. 3) was induced and compared to a non-fluorescent strain (negative), a strain with only the reporter construct (pGAL1-mScarlet), and a strain with constitutive expression of the fluorescent reporter (pRPL18B-mScarlet).

### Example 2—Combining optoPlate Programming with Automation Allows for High-Resolution Time-Course Experiments

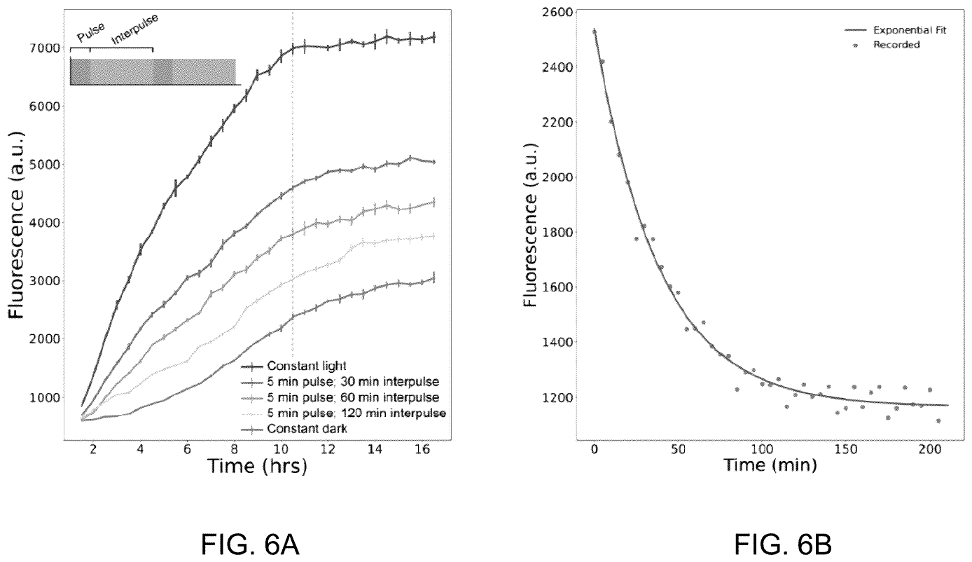

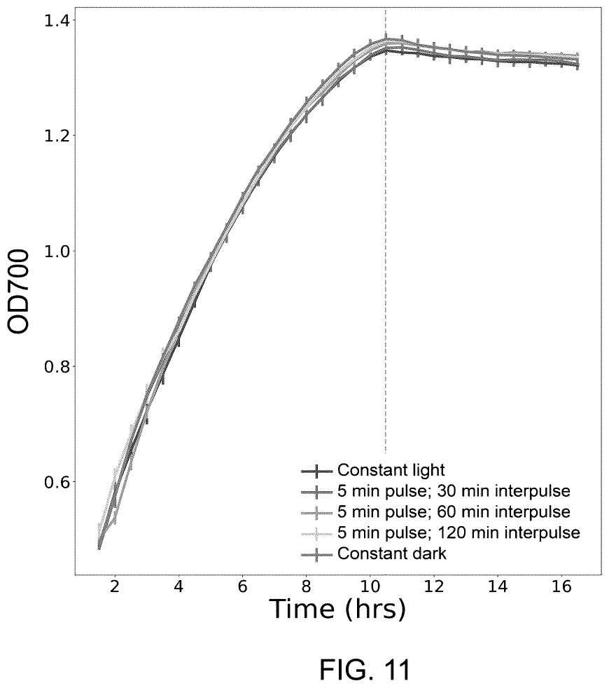

An advantage of Lustro is the ability to easily record output over time, as shown in FIG. 6. This can reveal dynamic changes which would not be observed using a single end point measurement. In addition, it is known that culture growth stage and saturation can affect optogenetic systems differently. Gene expression (using the fluorescent reporter) induced by a split TF (consisting of a cryptochrome variant, CRY2(535) and CIB1) was measured every 30 minutes for 16 hours (FIG. 6). Measurements were taken every 30 minutes and revealed behavior of the optogenetic system in response to different light induction programs as the cell culture reached saturation (compared to OD measurements in FIG. 11).

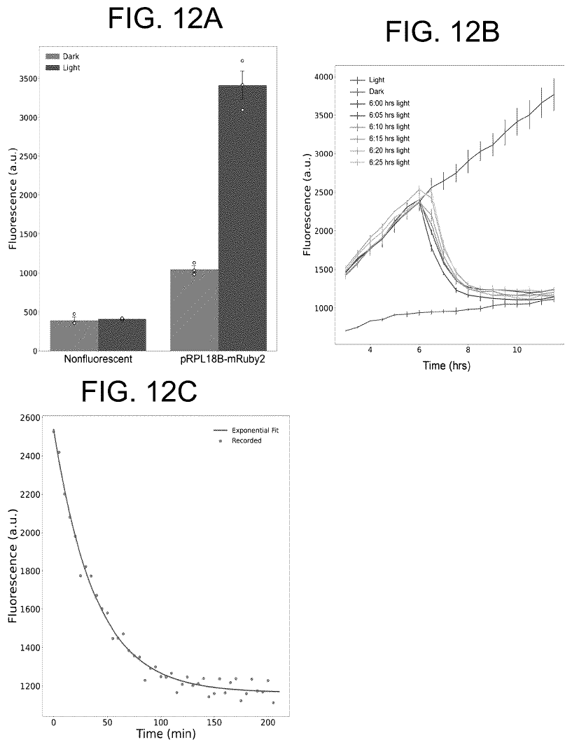

In preliminary experiments, strains were created using mRuby2 as a fluorescent reporter (later replaced with mScarlet). However, a strain with mRuby2 under constitutive expression (pRPL18B) was unexpectedly found to temporarily exhibit higher fluorescence following light induction (FIGS. 12A-12C). This effect did not depend on co-expression of an optogenetic system. The kinetics of this photoactivated effect were observed using the automated platform, which would not have been possible to observe by taking single measurements at a delayed endpoint. The short sampling time (3.5 minutes to shake and measure a plate) and the ability to program illumination means that measurements can be taken with even finer timescale resolution if duplicate wells were used, and illumination patterns were staggered. This approach was used to measure the timescale of the decay rate of the mRuby2 photoactivated effect. A strain constitutively expressing mRuby2 (pRPL18B-mRuby2) was induced with blue light and the timing of the light switching off between duplicate wells was staggered by 5-minute intervals so that measurements recorded on 30-minute intervals could show finer granularity (FIG. 12B). These measurements were combined and fit to an exponential decay curve (FIG. 12C) and the half-life of this photosensitive effect was found to be 26.5 minutes. Without being bound to theory, this effect may be related to the change in mRuby spectral properties observed in conjunction with changes in pH. While frustrating for measuring the response of blue-light stimulated optogenetic systems, this effect could potentially be leveraged for other applications. For instance, to track protein movement and localization by stimulating mRuby2 in a defined location and observing the change and movement of the photosensitive fluorescence effect.

### Example 3—A Yeast Optogenetic Toolkit (yOTK) Combined with Lustro Allows for Rapid Prototyping and Testing of Optogenetic Systems

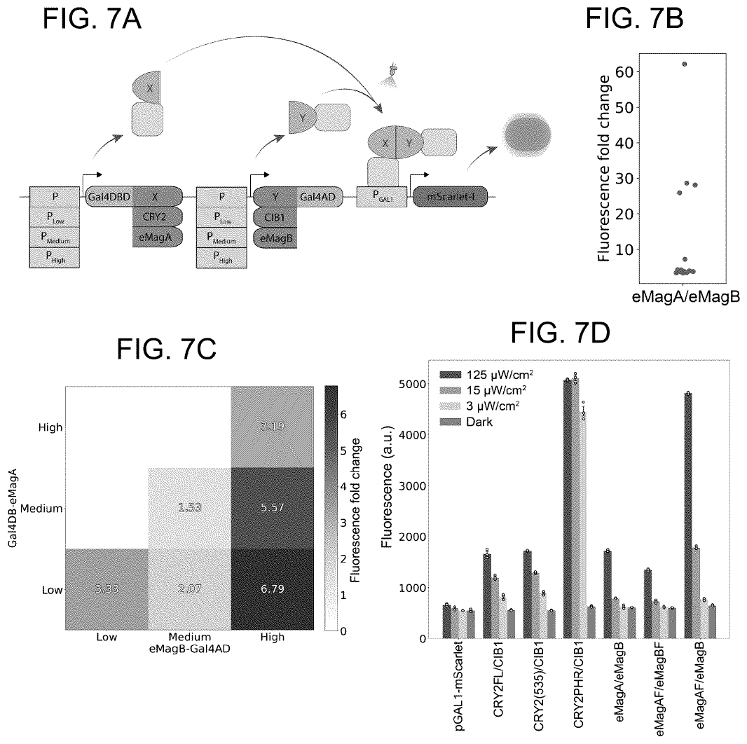

Optogenetic split transcription factors can, in theory, be built from any pair of optically dimerizing proteins. However, these proteins have different properties, including their light sensitivity, photocycle kinetics, as well as their sensitivity to protein fusion and context. In order to compare how different optical dimerizers tune the activity of optogenetic split TFs, new light-sensitive dimerizers were introduced as parts into the yeast optogenetic toolkit (yOTK). Specifically, several different cryptochrome variants (CRY2FL/CIB1, CRY2PH1R/CIB1, CRY2(535)/CIB1) and Enhanced Magnets (eMags) (eMagA/eMagB, eMagAF/eMagBF), selected to have different photocycle kinetics between light and dark states and light sensitivity (Table 1; see also Table 4 for full list of plasmids generated in this work) were introduced. Using the toolkit, these optical dimerizer pairs were cloned into the same cellular context (FIG. 7A) using Golden Gate assembly to rapidly and reliably assemble individual “part” plasmids into “cassette” plasmids containing split TFs that use the Gal4 activation domain (Gal4AD), the Gal4 DNA-binding domain (Gal4DBD), with the Gall promoter (pGAL1) driving expression of the fluorescent protein mScarlet. Cassettes containing the individual TF components (DBD, AD, or pGAL1) are further assembled into “multigene” plasmids for transformation into yeast.

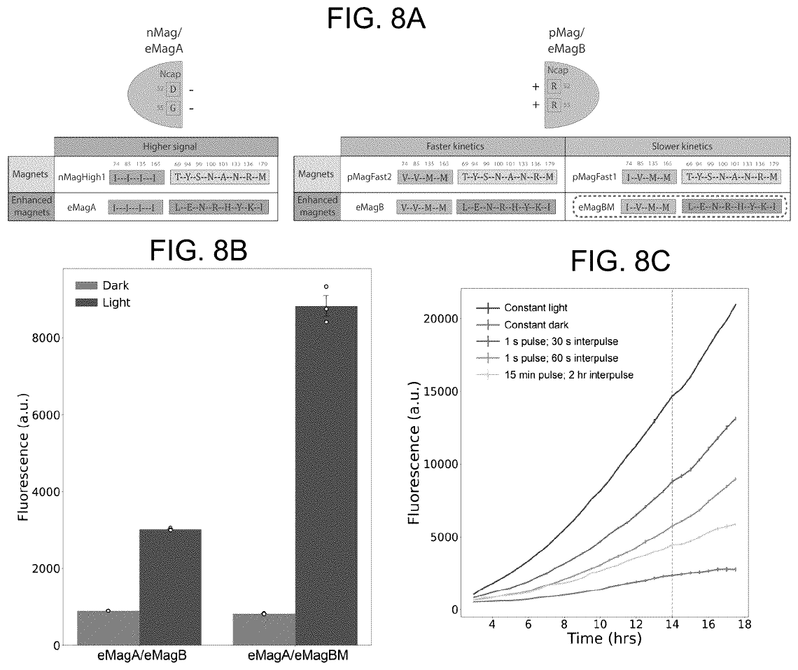

TABLE 1
Optogenetic Parts Added to the Yeast MoClo Toolkit.

| Dimerizer | | |
|---|---|---|
| variant | Binding partner | Description |
| eMagA | eMagB, eMagBF, or | Enhanced magnet dimerizer |
| | eMagBM | |
| eMagAF | eMagB, eMagBF, or | Enhanced magnet dimerizer |
| | eMagBM | with faster kinetics |
| eMagB | eMagA or eMagAF | Enhanced magnet dimerizer |
| eMagBF | eMagA or eMagAF | Enhanced magnet dimerizer |
| | | with faster kinetics |
| eMagBM | eMagA or eMagAF | Enhanced magnet dimerizer |
| | | with slower |
| | | kinetics (FIGs. 8A-8C) |
| CRY2FL | CIB1 | Full length CRY2 |
| CRY2PHR | CIB1 | CRY2 truncation |
| | | (residues 1-498 of CRY2) |
| CRY2(535) | CIB1 | CRY2 truncation |
| | | (residues 1-535 of CRY2) |

The Lustro system was used to test various induction programs and screen several colonies from each construct transformation. Different transformants of the same construct were found to have variable fold-change gene expression response to induction (FIG. 7B). It was hypothesized that these differences were due to copy number integration variation, as has been seen previously. Lustro allows for 46 transformants to be screened in each 96-well plate (light and dark conditions of each transformant alongside blank and negative controls, see FIG. 9), providing a robust and reliable method for identifying transformants with desired traits. For purposes of comparing the effects of different promoters and optical dimerizers, the lowest fold-change transformants were assumed to be single-copy integrations and selected. The transformants exhibiting a higher light-induced gene expression level, presumably due to multiple integrations, might be preferred for some applications and merit further exploration in a future study.

Tuning relative expression levels of the two components in split TF optogenetic systems is important for optimizing their activity. The yeast optogenetic toolkit was used to develop strains with the DBD and AD components under different strength promoters and rapidly tested the strains with the Lustro automated platform. Light-inducible split TF strains were generated with optical dimerizer eMagA and eMagB components under constitutive expression of low, medium, and high strength promoters (FIG. 7C). Using Lustro, all construct transformants were screened and tested in two days. The strains use pRPL18B as the low promoter, pHHF 1 as the medium, and pTEF1 as the high, based on characterizations done by Lee, et al 2015.

It was reasoned that excess expression levels of the DBD component relative to the AD component expression levels would result in suboptimal activation as there are limited binding sites in the genome and unbound DBD could sequester the AD component away from the DNA without providing gene expression activity. This effect has been seen in previous studies, which demonstrated that higher expression of the DBD component relative to the AD component suppressed light-induced gene expression. Thus, only strains were generated where the expression of the AD component is equal to or greater than the expression of the DBD component. For each expression strength of the AD component, a higher fold change in fluorescence corresponded to a lower expression strength of the DBD component, with the largest effect occurring for the AD component under highest expression and the DBD component under lowest expression (FIG. 7C, lower right).

Different optical dimerizers are known to exhibit different light sensitivity. The yOTK was used to generate strains with different optical dimerizers cloned into a similar split TF context and Lustro was used to characterize the light sensitivity of these strains (FIG. 7D). It was found that TFs using CRY2FL and CRY2(535) exhibited similar levels of sensitivity to light intensity, while the CRY2 PHR TF exhibited very high sensitivity to even low doses of constant light. CRY2 PHR is a truncation of CRY2FL that exhibits both higher basal and light-induced activity. CRY2(535) is an intermediate-length truncation that produces intermediate activation and background, as compared to CRY2FL and CRY2 PHR. Comparatively, TFs using the Enhanced Magnets (detailed below) exhibited less sensitivity to low levels of light intensity. TFs using a variant of eMagA/eMagB designed to have faster photocycle kinetics, eMagAF/eMagBF, had a lower gene expression response than TFs using eMagA/eMagBl, but similar light sensitivity. Surprisingly, a split TF using a combination of the two, eMagAF/eMagB, exhibited a much higher gene expression level (and somewhat higher light sensitivity) than TFs using either eMagA/eMagBl or eMagAF/eMagBF.

TABLE 2
Yeast Strains Used.

| ID | Alias | Genotype | Description | Source |
|---|---|---|---|---|
| yMM1444 | mRuby2 | Mat alpha trp1Δ63 | Benchmark | An-adirekkun et al. |
| | MEDIUM | leu2Δ1::LEU2- | for | 2020 Biotechnol |
| | | pRPL18B-mRUBY2- | mRuby2 | Bioeng |
| | | tADH1 ura3-52 | expression | |
| | | HO::S40NLS- | (pRPL18B) | |
| | | VP16AD- | | |
| | | CIB1 loxP-KlURA3- | | |
| | | loxP SV40NLS- | | |
| | | Zif268DBD- | | |
| | | CRY2PHR | | |
| yMM1715 | Ura int ctrl | BY4741 Matα | Ura3 | This work |
| | | ura3Δ0::URA3-sfGFP | integration | |
| | | his3D1 leu2D0 | control | |
| | | lys2D0 | | |
| | | gal80::KANMX | | |
| | | gal4::spHIS5 | | |
| yMM1728 | spacer, spacer, | BY4741 Matα | pGAL1- | This work |
| | pGAL1- | ura3Δ0::5′ Ura3 | mScarlet-I | |
| | mScarlet-I | homology, spacer, | control | |
| | | spacer, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1729 | spacer, spacer, | BY4741 Matα | pRPL18B- | This work |
| | pRPL18B- | ura3Δ0::5′ Ura3 | mScarlet-I | |
| | mScarlet-I | homology, spacer, | control | |
| | | spacer, pRPL18B- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1731 | pRPL18B- | BY4741 Matα | pRPL18B- | This work |
| | Gal4DBD- | ura3Δ0::5′ Ura3 | CRY2PHR, | |
| | CRY2PHR, | homology, pRPL18B- | pRPL18B- | |
| | pRPL18B- | Gal4DBD- | CIB1 | |
| | Gal4AD-CIB1, | CRY2PHR-tENO1, | | |
| | pGAL1- | pRPL18B-Gal4AD- | | |
| | mScarlet-I | CIB1-tENO1, | | |
| | | pGAL1-mScarlet-I- | | |
| | | tENO1, Ura3, Ura 3′ | | |
| | | homology his3D1 | | |
| | | leu2D0 lys2D0 | | |
| | | gal80::KANMX | | |
| | | gal4::spHIS5 | | |
| yMM1733 | pRPL18B- | BY4741 Matα | pRPL18B- | This work |
| | Gal4DBD- | ura3Δ0::5′ Ura3 | CRY2, | |
| | CRY2, | homology, pRPL18B- | pRPL18B- | |
| | pRPL18B- | Gal4DBD-CRY2- | CIB1 | |
| | Gal4AD-CIB1, | tENO1, pRPL18B- | | |
| | pGAL1- | Gal4AD-CIB1- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1734 | pRPL18B- | BY4741 Matα | pRPL18B- | This work |
| | Gal4DBD- | ura3Δ0::5′ Ura3 | eMagA, | |
| | eMagA, | homology, pRPL18B- | pRPL18B- | |
| | pRPL18B- | Gal4DBD-eMagA- | eMagB | |
| | eMagB-Gal4AD, | tENO1, pRPL18B- | | |
| | pGAL1- | eMagB-Gal4AD- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1760 | pRPL18B- | BY4741 Matα | pRPL18B- | This work |
| | Gal4DBD- | ura3Δ0::5′ Ura3 | eMagA, | |
| | eMagA, pTEF1- | homology, pRPL18B- | pTEF1- | |
| | eMagB-Gal4AD, | Gal4DBD-eMagA- | eMagB | |
| | pGAL1- | tENO1, pTEF1- | | |
| | mScarlet-I | eMagB-Gal4AD- | | |
| | | tENO1, pGAL1- | | |
| | | mScarlet-I-tENO1, | | |
| | | Ura3, Ura 3′ homology | | |
| | | KanR-ColE1 his3D1 | | |
| | | leu2D0 lys2D0 | | |
| | | gal80::KANMX | | |
| | | gal4::spHIS5 | | |
| yMM1761 | pTEF1- | BY4741 Matα | pTEF1- | This work |
| | Gal4DBD- | ura3Δ0::5′ Ura3 | eMagA, | |
| | eMagA, pTEF1- | homology, pTEF1- | pTEF1- | |
| | eMagB-Gal4AD, | Gal4DBD-eMagA- | eMagB | |
| | pGAL1- | tENO1, pTEF1- | | |
| | mScarlet-I | eMagB-Gal4AD- | | |
| | | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1763 | pRPL18B- | BY4741 Matα | pRPL18B- | This work |
| | Gal4DBD- | ura3Δ0::5′ Ura3 | CRY2(535), | |
| | CRY2(535), | homology, pRPL18B- | pRPL18B- | |
| | pRPL18B- | Gal4DBD- | CIB1 | |
| | Gal4AD-CIB1, | CRY2(535)-tENO1, | | |
| | pGAL1- | pRPL18B-Gal4AD- | | |
| | mScarlet-I | CIB1-tENO1, | | |
| | | pGAL1-mScarlet-I- | | |
| | | tENO1, Ura3, Ura 3′ | | |
| | | homology his3D1 | | |
| | | leu2D0 lys2D0 | | |
| | | gal80::KANMX | | |
| | | gal4::spHIS5 | | |
| yMM1764 | pRPL18B- | BY4741 Matα | pRPL18B- | This work |
| | Gal4DBD- | ura3Δ0::5′ Ura3 | eMagAF, | |
| | eMagAF, | homology, pRPL18B- | pRPL18B- | |
| | pRPL18B- | Gal4DBD-eMagAF- | eMagBF | |
| | eMagBF- | tENO1, pRPL18B- | | |
| | Gal4AD, | eMagBF-Gal4AD- | | |
| | pGAL1- | tENO1, pGAL1- | | |
| | mScarlet-I | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1765 | pRPL18B- | BY4741 Matα | pRPL18B- | This work |
| | Gal4DBD- | ura3Δ0::5′ Ura3 | eMagA, | |
| | eMagA, | homology, pRPL18B- | pRPL18B- | |
| | pRPL18B- | Gal4DBD-eMagA- | eMagBM | |
| | eMagBM- | tENO1, pRPL18B- | | |
| | Gal4AD, | eMagBM-Gal4AD- | | |
| | pGAL1- | tENO1, pGAL1- | | |
| | mScarlet-I | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1769 | pRPL18B- | BY4741 Matα | pRPL18B-- | This work |
| | Gal4DBD- | ura3Δ0::5′ Ura3 | eMagA, | |
| | eMagA, pHHF1- | homology, pRPL18B- | pHHF1- | |
| | eMagBM- | Gal4DBD-eMagA- | eMagBM | |
| | Gal4AD, | tENO1, pHHF1- | | |
| | pGAL1- | eMagBM-Gal4AD- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1770 | pRPL18B- | BY4741 Matα | pRPL18B- | This work |
| | Gal4DBD- | ura3Δ0::5′ Ura3 | eMagA, | |
| | eMagA, pTEF1- | homology, pRPL18B- | pTEF1- | |
| | eMagBM- | Gal4DBD-eMagA- | eMagBM | |
| | Gal4AD, | tENO1, pTEF1- | | |
| | pGAL1- | eMagBM-Gal4AD- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1771 | pHHF1- | BY4741 Matα | pHHF1- | This work |
| | Gal4DBD- | ura3Δ0::5′ Ura3 | eMagA, | |
| | eMagA, pHHF1- | homology, pHHF1- | pHHF1- | |
| | eMagBM- | Gal4DBD-eMagA- | eMagBM | |
| | Gal4AD, | tENO1, pHHF1- | | |
| | pGAL1- | eMagBM-Gal4AD- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1772 | pHHF1- | BY4741 Matα | pHHF1- | This work |
| | Gal4DBD- | ura3Δ0::5′ Ura3 | eMagA, | |
| | eMagA, pTEF1- | homology, pHHF1- | pTEF1- | |
| | eMagBM- | Gal4DBD-eMagA- | eMagBM | |
| | Gal4AD, | tENO1, pTEF1- | | |
| | pGAL1- | eMagBM-Gal4AD- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS5 | | |
| yMM1773 | pTEF1- | BY4741 Matα | pTEF1- | This work |
| | Gal4DBD- | ura3Δ0::5′ Ura3 | eMagA, | |
| | eMagA, pTEF1- | homology, pTEF1- | pTEF1- | |
| | eMagBM- | Gal4DBD-eMagA- | eMagBM | |
| | Gal4AD, | tENO1, pTEF1- | | |
| | pGAL1- | eMagBM-Gal4AD- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS6 | | |
| yMM1774 | pRPL18B- | BY4741 Matα | pRPL18B- | This work |
| | Gal4DBD- | ura3Δ0::5′ Ura3 | eMagA, | |
| | eMagA, pHHF1- | homology, pRPL18B- | pHHF1- | |
| | eMagB-Gal4AD, | Gal4DBD-eMagA- | eMagB | |
| | pGAL1- | tENO1, pHHF1- | | |
| | mScarlet-I | eMagB-Gal4AD- | | |
| | | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS6 | | |
| yMM1775 | pHHF1- | BY4741 Matα | pHHF1- | This work |
| | Gal4DBD- | ura3Δ0::5′ Ura3 | eMagA, | |
| | eMagA, pHHF1- | homology, pHHF1- | pHHF1- | |
| | eMagB-Gal4AD, | Gal4DBD-eMagA- | eMagB | |
| | pGAL1- | tENO1, pHHF1- | | |
| | mScarlet-I | eMagB-Gal4AD- | | |
| | | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS6 | | |
| yMM1776 | pHHF1- | BY4741 Matα | pHHF1- | This work |
| | Gal4DBD- | ura3Δ0::5′ Ura3 | eMagA, | |
| | eMagA, pTEF1- | homology, pHHF1- | pTEF1- | |
| | eMagB-Gal4AD, | Gal4DBD-eMagA- | eMagB | |
| | pGAL1- | tENO1, pTEF1- | | |
| | mScarlet-I | eMagB-Gal4AD- | | |
| | | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS6 | | |
| yMM1778 | pRPL18B- | BY4741 Matα | pRPL18B- | This work |
| | Gal4DBD- | ura3Δ0::5′ Ura3 | eMagAF, | |
| | eMagAF, | homology, pRPL18B- | pRPL18B- | |
| | pRPL18B- | Gal4DBD-eMagAF- | eMagB | |
| | eMagB-Gal4AD, | tENO1, pRPL18B- | | |
| | pGAL1- | eMagB-Gal4AD- | | |
| | mScarlet-I | tENO1, pGAL1- | | |
| | | mScarlet-I-tENO1, | | |
| | | Ura3, Ura 3′ homology | | |
| | | his3D1 leu2D0 | | |
| | | lys2D0 | | |
| | | gal80::KANMX | | |
| | | gal4::spHIS7 | | |

TABLE 3
Primers Used.

| ID | Alias | Sequence | Target | Purpose |
|---|---|---|---|---|
| oMM2093 | Fwd NLS- | GCATCGTCTC | NLS-GAL4AD- | Amplify NLS- |
| | GAL4AD- | ATCGGTCTCA | CIB1 | GAL4AD-CIB1 |
| | CIB1/N/81 3 | TATGgataaagcg | | from Addgene |
| | | gaattaattccc | | #28245 |
| | | | | (pMM0159) to |
| | | | | insert into a part |
| | | | | 3 vector |
| oMM2094 | Rev NLS- | ATGCCGTCTC | NLS-GAL4AD- | Amplify NLS- |
| | GAL4AD- | AGGTCTCAGG | CIB1 | GAL4AD-CIB1 |
| | CIB1/N 3 | ATccgtatctacgatt | | from Addgene |
| | | catctgcagc | | #28245 |
| | | | | (pMM0159) to |
| | | | | insert into a part |
| | | | | 3 vector. Adds a |
| | | | | GG |
| oMM2096 | Fwd GAL4BD | GCATCGTCTC | GAL4DBD | Amplify |
| | 3a | ATCGGTCTCA | | GAL4DBD from |
| | | TATGaagctactgt | | Addgene #28244 |
| | | cttctatcg | | (pMM0212) to |
| | | | | insert into a part |
| | | | | 3a vector |
| oMM2097 | Rev GAL4BD 3a | ATGCCGTCTC | GAL4DBD | Amplify |
| | | AGGTCTCAAG | | GAL4DBD from |
| | | AAcccgatacagtc | | Addgene #28244 |
| | | aactgtctttg | | (pMM0212) to |
| | | | | insert into a part |
| | | | | 3a vector. Adds a |
| | | | | GG. |
| oMM2098 | Fwd- | GCATCGTCTC | -CRY2/PHR/535 | Amplify -CRY2, |
| | CRY2/PHR/515/ | ATCGGTCTCA | | PHR, 535 from |
| | 535 3b | TTCTacaggtgcta | | pMM0521 to |
| | | gcttcatg | | insert into a part |
| | | | | 3b vector |
| oMM2100 | Rev-CRY2(535) | ATGCCGTCTC | -CRY2(535) | Amplify |
| | 3b | AGGTCTCAGG | | -CRY2(535) |
| | | ATCCaacagccga | | from pMM0521 to |
| | | aggtacttg | | insert into a part |
| | | | | 3b vector. Adds a |
| | | | | GG |
| oMM2130 | Fwd VVD- | GCATCGTCTC | VVD-Gal4AD | Amplify VVD- |
| | Gal4AD 3 part | ATCGGTCTCA | | Gal4AD from |
| | | TatgAGCCATA | | pRS425-VVD to |
| | | CCGTGAACTC | | make a type 3B |
| | | | | part |
| oMM2131 | Rev VVD- | ATGCCGTCTC | VVD-Gal4AD | Amplify VVD- |
| | Gal4AD 3 part | AGGTCTCAGG | | Gal4AD from |
| | | ATccTGAACC | | pRS425-VVD to |
| | | AGCGTAATCT | | make a type 3B |
| | | GGTAC | | part. Adds a GG |
| oMM2675 | Fwd mScarlet-I | gcatCGTCTCaT | mScarlet-I | Amplify |
| | 3 part | CGGTCTCAtatg | | mScarlet-I from |
| | | ATGGTAAGC | | pMM0610 to |
| | | AAAGGTGAG | | make a type 3 |
| | | G | | part |
| oMM2676 | Rev mScarlet-I | atgcCGTCTCaG | mScarlet-I | Amplify |
| | 3 part | GTCTCaggatCT | | mScarlet-I from |
| | | ACTTATATAA | | pMM0610 to |
| | | TTCGTCCATG | | make a type 3 |
| | | CC | | part |
| oMM2677 | Fwd Gal4AD c- | gcatCGTCTCaT | Gal4AD | Amplify Gal4AD |
| | term 3B | CGGTCTCAttct | | from pMM0928 |
| | | GATAAAGCG | | to make a type 3B |
| | | GAATTAATTC | | part |
| | | CCG | | |
| oMM2678 | Rev Gal4AD c- | atgcCGTCTCaG | Gal4AD | Amplify Gal4AD |
| | term 3B | GTCTCaggatTT | | from pMM0928 |
| | | ACTCTTTTTT | | to make a type 3B |
| | | TGGGTTTGGT | | part |
| | | GG | | |
| oMM2683 | Fwd eMagB Q5 | AACACTATCT | eMagB | Q5 to make |
| | Y99F | tCACCATGAA | | eMagBF (Y99F) |
| | | GAAGG | | |
| oMM2684 | Rev eMagB Q5 | GGAGTCCAC | eMagB | Q5 to make |
| | Y99F | GTATTTGCG | | eMagBF (Y99F) |
| oMM2685 | Fwd eMagA Q5 | AACACGATCT | eMagA | Q5 to make |
| | Y99F | tCACCATCAA | | eMagAF (Y99F) |
| | | G | | |
| oMM2686 | Rev eMagA Q5 | CGAGTCCACA | eMagA | Q5 to make |
| | Y99F | TATTTGCG | | eMagAF (Y99F) |
| oMM2687 | Fwd eMagB | GGCGAATAC | eMagB | Make eMagB |
| | backbone | CGGTACAGC | | backbone for |
| | | ATC | | Gibson |
| oMM2688 | Rev eMagB | aggggtgtccttctgct | eMagB | Make eMagB |
| | backbone(I) | taaggtcacacagG | | backbone (I-) for |
| | | ATgagggcgcagg | | Gibson |
| | | agaggtc | | |
| oMM2689 | Fwd eMagB- | ttaagcagaaggaca | eMagB | Make eMagB- |
| | VMM insert | cccctgtg | | VMM insert for |
| | | | | Gibson |
| oMM2691 | Rev eMagB | GATGCTGTAC | eMagB | Make eMagB |
| | insert | CGGTATTCGC | | insert for Gibson |
| | | C | | |

### Example 4—Combining the yOTK and Lustro to Generate an Optimized Magnet-Based Split TF

The original Magnet proteins were developed by introducing positively and negatively charged residues into the Ncap homodimer interface of the homodimerizer protein Vivid, a naturally occurring light-sensitive protein in Neurospora crassa. Subsequent mutations were introduced to reduce (pMagFast2) or increase (nMagHigh1) reversion time to the dark state. The Enhanced Magnets eMagA and eMagB developed in another study were generated from nMagHigh1 and pMagFast2 (respectively) by introducing mutations to improve thermal stability and binding activity. To develop a version of eMagB that reverts to the dark state more slowly, these “enhanced” mutations were introduced into another Magnet protein, pMagFast1 (a slower reverting version of pMagFast2), generating an “enhanced” pMagFast1 protein, eMagBM (FIG. 8A).

The Lustro system, as described in the present application was used to characterize split TFs with eMagBM and compare them to split TFs using eMagB. Induction with eMagBM-based TFs was found to be higher than induction with eMagB-based TFs as had been anticipated (FIG. 8B) and was tunable by varying light pulse and interpulse duration (FIG. 4C). Interestingly, induction with the Magnet-based TFs was found to continue to increase fluorescence even after cultures reached saturation at around 12 hours (data shown for eMagA/eMagBM in FIG. 8C), which might be useful for high cell density bioproduction schemes. This contrasts with the activity of the CRY2/CIB1-based TFs (data shown for CRY2 PHR/CIB1 in FIG. 6), where fluorescence plateaus around the saturation point at 10 hours.

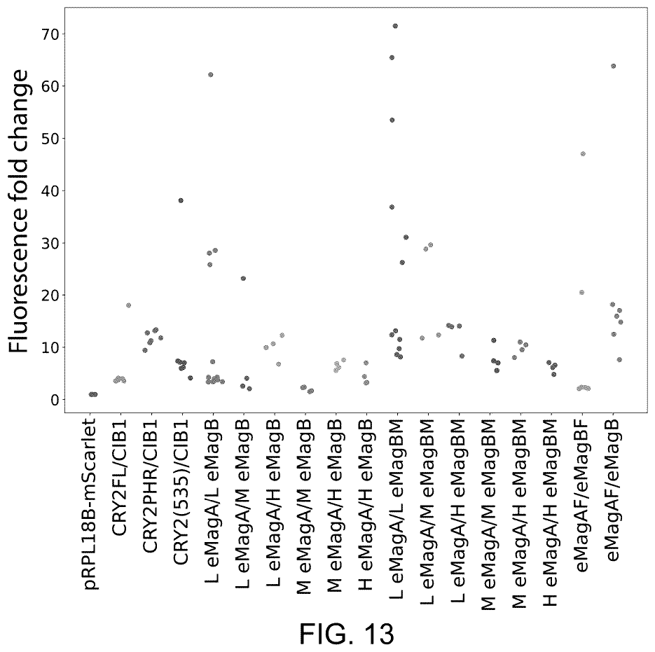

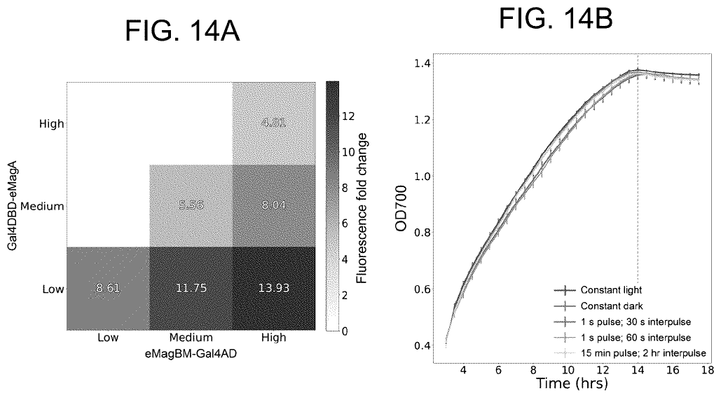

To further optimize the eMagA/eMagBM split TF, constructs were cloned with the components of the eMagBM-based split TF system each expressed under different promoter strengths, as was done with the eMagA/eMagB split TF in FIG. 7C. Transformants were screened as shown in FIG. 7B to identify single-copy integrations for comparison (FIG. 13). Different expression levels of the eMagA/eMagBM split TF exhibited a similar pattern to the expression levels of the eMagA/eMagB split TF shown in FIG. 7C, but with a higher expression of the reporter at all component expression levels (FIGS. 14A and 14B).

### Example 5—Materials and Methods

### Strains, Media, and Culture Conditions

Single-construct strains were assembled by transforming NotI-digested multigene plasmids into BY474153 Saccharomyces cerevisiae MATα HIS3D1 LEU2DO LYS2D0 URA3D0 GAL80::KANMX GAL4::spHIS5. Transformations were performed according to an established LiAc/SS carrier DNA/PEG protocol54. Constructs were genomically integrated to reduce cell-to-cell variability. Integrations were done at the URA3 site and transformants were selected using SC-Ura dropout media.

Yeast strains were inoculated from colonies on a YPD agar plate into 3 mL liquid SC media and grown overnight at 30° C., shaking. Overnight cultures were diluted to OD700=0.1 in SC media. 200 μL of each culture was then added to each well of a 96-well black-wall, glass-bottom plate (Cat. #P96-1.5H-N). OD700 was used to avoid bias from the red fluorescent mScarlet-I. All strains and conditions were measured in triplicate after initial transformant screening.

Cloning was carried out using a modular cloning toolkit as previously described. In brief, part plasmids were constructed using BsmBI Golden Gate assembly of PCR products (primers are listed in Table 3) or gBlocks (gene blocks used are listed in Table 5) into the part plasmid entry vector (yTK001). Optogenetic constructs are listed in Table 6. Part plasmids were subsequently assembled into cassette plasmids using BsaI Golden Gate assembly. Cassette plasmids were assembled into multigene plasmids using BsmBI Golden Gate assembly.

TABLE 4
Plasmids Used.

| | | | Yeast | Bacterial | Toolkit | |
|---|---|---|---|---|---|---|
| ID | Alias | Gene(s) or Insert | Marker | Resistance | Part | Source |
| pMM0159 | pGal4AD- | GAL4AD-CIB1 | LEU2 | AmpR | N/A | Kennedy |
| | CIB1 | | | | | et al. 2010 |
| | (Addgene | | | | | Nature |
| | #28245) | | | | | Methods |
| pMM0212 | pGal4DBD- | GAL4BD-CRY2PHR | TRP1 | KanR | N/A | Kennedy |
| | CRY2PHR | TRP1 | | | | et al. 2010 |
| | (Addgene | | | | | Nature |
| | #28244) | | | | | Methods |
| pMM0452 | Entry vector | ColE1-CamR-sfGFP | | CamR | Entry | Lee et al. |
| | (pYTK001; | dropout | | | vector | 2015 Acs |
| | Addgene | | | | | Syn Bio |
| | #65108) | | | | | |
| pMM0454 | pRPL18B | ColE1-CamR- | | CamR | Part, Type | Lee et al. |
| | (pYTK017; | pRPL18B | | | 2 | 2015 Acs |
| | Addgene | | | | | Syn Bio |
| | #65124) | | | | | |
| pMM0458 | GFP dropout | ColE1-KanR-URA3 | URA3 | KanR | GFP | Lee et al. |
| | cassette | 3′ homology-URA3- | | | dropout | 2015 Acs |
| | (pYTK096) | sfGFP dropout-URA3 | | | cassette | Syn Bio |
| | | 5′ homology | | | | |
| pMM0479 | LEU2 | ColE1-CamR-LEU2 | | CamR | Part, Type | Lee et al. |
| | (pYTK075; | | | | 6 | 2015 Acs |
| | Addgene | | | | | Syn Bio |
| | #65182) | | | | | |
| pMM0489 | ConLS | ColE1-CamR-ConLS | | CamR | Part, Type | Lee et al. |
| | (pYTK002; | | | | 1 | 2015 Acs |
| | Addgene | | | | | Syn Bio |
| | #65109) | | | | | |
| pMM0491 | ConR1 | ColE1-CamR-ConR1 | | CamR | Part, Type | Lee et al. |
| | (pYTK067; | | | | 5 | 2015 Acs |
| | Addgene | | | | | Syn Bio |
| | #65174) | | | | | |
| pMM0521 | NLS- | SV40NLS- | TRP1 | AmpR | N/A | An- |
| | ZIF268DBD- | Zif268DBD-CRY2 | | | | adirekkun |
| | CRY2 (L3) | (L3) scTRP1 | | | | et al. 2020 |
| | | | | | | Biotechnol |
| | | | | | | Bioeng |
| pMM0522 | pTEF1 | ColE1-CamR-pTEF1 | | CamR | Part, Type | Lee et al. |
| | (pYTK013; | | | | 2 | 2015 Acs |
| | Addgene | | | | | Syn Bio |
| | #65120) | | | | | |
| pMM0524 | CEN6/ARS4 | ColE1-CamR- | | CamR | Part, Type | Lee et al. |
| | (pYTK081; | CEN6/ARS4 | | | 7 | 2015 Acs |
| | Addgene | | | | | Syn Bio |
| | #65188) | | | | | |
| pMM0525 | RFP | ColE1-KanR-RFP | | KanR | Part, Type | Lee et al. |
| | (pYTK084; | | | | 8 | 2015 Acs |
| | Addgene | | | | | Syn Bio |
| | #65191) | | | | | |
| pMM0532 | ConL1 | ColE1-CamR-ConL1 | | CamR | Part, Type | Lee et al. |
| | (pYTK003; | | | | 1 | 2015 Acs |
| | Addgene | | | | | Syn Bio |
| | #65110) | | | | | |
| pMM0533 | ConL2 | ColE1-CamR-ConL2 | | CamR | Part, Type | Lee et al. |
| | (pYTK004; | | | | 1 | 2015 Acs |
| | Addgene | | | | | Syn Bio |
| | #65111) | | | | | |
| pMM0537 | ConR2 | ColE1-CamR-ConR2 | | CamR | Part, Type | Lee et al. |
| | (pYTK068; | | | | 5 | 2015 Acs |
| | Addgene | | | | | Syn Bio |
| | #65175) | | | | | |
| pMM0541 | ConRE | ColE1-CamR-ConRE | | CamR | Part, Type | Lee et al. |
| | (pYTK072; | | | | 5 | 2015 Acs |
| | Addgene | | | | | Syn Bio |
| | #65179) | | | | | |
| pMM0542 | tENO1 | ColE1-CamR-tENO1 | | CamR | Part, Type | Lee et al. |
| | (pYTK051; | | | | 4 | 2015 Acs |
| | Addgene | | | | | Syn Bio |
| | #65158) | | | | | |
| pMM0547 | Spacer | ColE1-CamR-Spacer | | CamR | Spacer | Lee et al. |
| | (pYTK048; | | | | | 2015 Acs |
| | Addgene | | | | | Syn Bio |
| | #65155) | | | | | |
| pMM0556 | sfGFP | ColE1-AmpR-sfGFP | | AmpR | 678 | Lee et al. |
| | dropout | dropout | | | | 2015 Acs |
| | (pYTK095; | | | | | Syn Bio |
| | Addgene | | | | | |
| | #65202) | | | | | |
| pMM0610 | mScarlet-I | mSCarlet-I caURA3 | URA3 | AmpR | N/A | Bindels et |
| | | | | | | al. 2016 |
| | | | | | | Nature |
| | | | | | | Methods |
| pMM0773 | Spacer | ConLS-Spacer- | | AmpR | Cassette | This work |
| | | ConR1-Amp/Cole1 | | | | |
| pMM0777 | Spacer | ConL1-Spacer- | | AmpR | Cassette | Geller et |
| | | ConR2-Leu2- | | | | al. 2019 |
| | | CEN/ARS-ColE1- | | | | Cell Mol |
| | | KanR | | | | Bioeng |
| pMM0916 | GAL4AD- | GAL4AD-CIB1 | LEU2 | AmpR | | This work |
| | CIB1 | (domesticated) | | | | |
| pMM0918 | Gal4DBD (n- | ColE1-CamR- | | CamR | Part, Type | This work |
| | terminal) | Gal4DBD | | | 3a | |
| pMM0920 | CRY2(535) | ColE1-CamR- | | CamR | Part, Type | This work |
| | | CRY2(535) | | | 3b | |
| pMM0921 | CRY2PHR | ColE1-CamR- | | CamR | Part, Type | This work |
| | | CRY2PHR | | | 3b | |
| pMM0922 | CRY2FL | ColE1-CamR- | | CamR | Part, Type | This work |
| | | CRY2FL | | | 3b | |
| pMM0923 | Gal4AD- | ColE1-CamR- | | CamR | Part, Type | This work |
| | CIB1 | Gal4AD-CIB1 | | | 3 | |
| pMM0928 | VVD- | ColE1-CamR-VVD- | | CamR | Part, Type | This work |
| | Gal4AD | Gal4AD | | | 3 | |
| pMM0939 | pGAL1 | ColE1-CamR-pGAL1 | | CamR | Part, Type | Lee et al. |
| | (pYTK030; | | | | 2 | 2015 Acs |
| | #Addgene | | | | | Syn Bio |
| | #65137) | | | | | |
| pMM0943 | pRPL18B- | ConLS-pRPL18B- | | AmpR | Cassette | This work |
| | Gal4DBD- | Gal4DBD- | | | | |
| | CRY2(535) | CRY2(535)-tENO1- | | | | |
| | cassette | ConR1 | | | | |
| pMM0944 | pRPL18B- | ConLS-pRPL18B- | | AmpR | Cassette | This work |
| | Gal4DBD- | Gal4DBD- | | | | |
| | CRY2PHR | CRY2PHR-tENO1- | | | | |
| | cassette | ConR1 | | | | |
| pMM0945 | pRPL18B- | ConLS-pRPL18B- | | AmpR | Cassette | This work |
| | Gal4DBD- | Gal4DBD-CRY2FL- | | | | |
| | CRY2FL | tENO1-ConR1 | | | | |
| | cassette | | | | | |
| pMM0946 | pRPL18B- | ConL1-pRPL18B- | | AmpR | Cassette | This work |
| | Gal4AD- | Gal4AD-CIB1- | | | | |
| | CIB1 | tENO1-ConR2 | | | | |
| | cassette | | | | | |
| pMM1104 | pHHF1 | ColE1-CamR-pHHF1 | | CamR | Part, Type | Lee et al. |
| | (pYTK012; | | | | 2 | 2015 Acs |
| | #Addgene | | | | | Syn Bio |
| | #65119) | | | | | |
| pMM1235 | mScarlet-I | ColE1-CamR- | | CamR | Part, Type | This work |
| | | mScarlet-I | | | 3 | |
| pMM1236 | pGAL1- | ConL2-pGAL1- | | AmpR | Cassette | This work |
| | mScarlet | mScarlet-I-tENO1- | | | | |
| | cassette | ConRE | | | | |
| pMM1237 | pRPL18B- | ConL2-pRPL18B- | | AmpR | Cassette | This work |
| | mScarlet-I | mScarlet-I-tENO1- | | | | |
| | cassette | ConRE | | | | |
| pMM1239 | spacer, | 5′ Ura3 homology, | URA3 | KanR | Multigene | This work |
| | spacer, | spacer, spacer, | | | | |
| | pGAL1- | pGAL1-mScarlet-I- | | | | |
| | mScarlet-I | tENO1, Ura3, Ura 3′ | | | | |
| | | homology KanR- | | | | |
| | | ColE1 | | | | |
| pMM1240 | spacer, | 5′ Ura3 homology, | URA3 | KanR | Multigene | This work |
| | spacer, | spacer, spacer, | | | | |
| | pRPL18B- | pRPL18B-mScarlet-I- | | | | |
| | mScarlet-I | tENO1, Ura3, Ura 3′ | | | | |
| | multigene | homology KanR- | | | | |
| | | ColE1 | | | | |
| pMM1242 | pRPL18B- | 5′ Ura3 homology, | URA3 | KanR | Multigene | This work |
| | Gal4DBD- | pRPL18B-Gal4DBD- | | | | |
| | CRY2PHR, | CRY2PHR-tENO1, | | | | |
| | pRPL18B- | pRPL18B-Gal4AD- | | | | |
| | Gal4AD- | CIB1-tENO1, | | | | |
| | CIB1, | pGAL1-mScarlet-I- | | | | |
| | pGAL1- | tENO1, Ura3, Ura 3′ | | | | |
| | mScarlet-I | homology KanR- | | | | |
| | | ColE1 | | | | |
| pMM1244 | pRPL18B- | 5′ Ura3 homology, | URA3 | KanR | Multigene | This work |
| | Gal4DBD- | pRPL18B-Gal4DBD- | | | | |
| | CRY2FL, | CRY2FL-tENO1, | | | | |
| | pRPL18B- | pRPL18B-Gal4AD- | | | | |
| | Gal4AD- | CIB1-tENO1, | | | | |
| | CIB1, | pGAL1-mScarlet-I- | | | | |
| | pGAL1- | tENO1, Ura3, Ura 3′ | | | | |
| | mScarlet-I | homology KanR- | | | | |
| | | ColE1 | | | | |
| pMM1245 | eMagB | ColE1-CamR-eMagB | | CamR | Part, Type | This work |
| | | | | | 3a | |
| pMM1246 | eMagA | ColE1-CamR-eMagA | | CamR | Part, Type | This work |
| | | | | | 3b | |
| pMM1247 | Gal4AD | ColE1-CamR- | | CamR | Part, Type | This work |
| | | Gal4AD | | | 3b | |
| pMM1248 | pRPL18B- | ConLS-pRPL18B- | | AmpR | Cassette | This work |
| | Gal4DBD- | Gal4DBD-eMagA- | | | | |
| | eMagA | tENO1-ConR1 | | | | |
| pMM1249 | ConL1- | ConL1-pRPL18B- | | AmpR | Cassette | This work |
| | pRPL18B- | eMagB-Gal4AD- | | | | |
| | eMagB- | tENO1-ConR2 | | | | |
| | Gal4AD | | | | | |
| pMM1250 | pRPL18B- | 5′ Ura3 homology, | URA3 | KanR | Multigene | This work |
| | Gal4DBD- | pRPL18B-Gal4DBD- | | | | |
| | eMagA, | eMagA-tENO1, | | | | |
| | pRPL18B- | pRPL18B-eMagB- | | | | |
| | eMagB-AD, | AD-tENO1, pGAL1- | | | | |
| | pGAL1- | mScarlet-I-tENO1, | | | | |
| | mScarlet-I | Ura3, Ura 3′ | | | | |
| | | homology KanR- | | | | |
| | | ColE1 | | | | |
| pMM1251 | pTEF1- | ConLS-pTEF1- | | AmpR | Cassette | This work |
| | Gal4DBD- | Gal4DBD-eMagA- | | | | |
| | eMagA | tENO1-ConR1 | | | | |
| pMM1252 | pTEF1- | ConL1-pTEF1- | | AmpR | Cassette | This work |
| | eMagB- | eMagB-Gal4AD- | | | | |
| | Gal4AD | tENO1-ConR2 | | | | |
| pMM1253 | pRPL18B- | 5′ Ura3 homology, | URA3 | KanR | Multigene | This work |
| | Gal4DBD- | pRPL18B-Gal4DBD- | | | | |
| | eMagA, | eMagA-tENO1, | | | | |
| | pTEF1- | pTEF1-eMagB-AD- | | | | |
| | eMagB-AD, | tENO1, pGAL1- | | | | |
| | pGAL1- | mScarlet-I-tENO1, | | | | |
| | mScarlet-I | Ura3, Ura 3′ | | | | |
| | | homology KanR- | | | | |
| | | ColE1 | | | | |
| pMM1254 | pTEF1- | 5′ Ura3 homology, | URA3 | KanR | Multigene | This work |
| | Gal4DBD- | pTEF1-Gal4DBD- | | | | |
| | eMagA, | eMagA-tENO1, | | | | |
| | pTEF1- | pTEF1-eMagB-AD- | | | | |
| | eMagB-AD, | tENO1, pGAL1- | | | | |
| | pGAL1- | mScarlet-I-tENO1, | | | | |
| | mScarlet-I | Ura3, Ura 3 | | | | |
| | | homology KanR- | | | | |
| | | ColE1 | | | | |
| pMM1257 | Gal4DBD- | 5′ Ura3 homology, | URA3 | KanR | Multigene | This work |
| | CRY2(535) | pRPL18B-Gal4DBD- | | | | |
| | Gal4AD- | CRY2(535)-tENO1, | | | | |
| | CIB1, | pRPL18B-Gal4AD- | | | | |
| | pGAL1- | CIB1-tENO1, | | | | |
| | mScarlet-I | pGAL1-mScarlet-I- | | | | |
| | | tENO1, Ura3, Ura 3′ | | | | |
| | | homology KanR- | | | | |
| | | ColE1 | | | | |
| pMM1258 | eMagBF | ColE1-CamR- | | CamR | Part, Type | This work |
| | | eMagBF | | | 3a | |
| pMM1259 | eMagAF | ColE1-CamR- | | CamR | Part, Type | This work |
| | | eMagAF | | | 3b | |
| pMM1260 | eMagBM | ColE1-CamR- | | CamR | Part, Type | This work |
| | | eMagBM | | | 3a | |
| pMM1263 | pRPL18B- | ConLS-pRPL18B- | | AmpR | Cassette | This work |
| | Gal4DBD- | Gal4DBD-eMagAF- | | | | |
| | eMagAF | tENO1-ConR1 | | | | |
| pMM1264 | pRPL18B- | ConL1-pRPL18B- | | AmpR | Cassette | This work |
| | eMagBF- | eMagBF-Gal4AD- | | | | |
| | Gal4AD | tENO1-ConR2 | | | | |
| pMM1265 | pRPL18B- | ConL1-pRPL18B- | | AmpR | Cassette | This work |
| | eMagBM- | eMagBM-Gal4AD- | | | | |
| | Gal4AD | tENO1-ConR2 | | | | |
| pMM1269 | pRPL18B- | 5′ Ura3 homology, | URA3 | KanR | Multigene | This work |
| | Gal4DBD- | pRPL18B-Gal4DBD- | | | | |
| | eMagAF- | eMagAF-tENO1, | | | | |
| | tENO1, | pRPL18B-eMagBF- | | | | |
| | pRPL18B- | Gal4AD-tENO1, | | | | |
| | eMagBF- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet | | | | | |
| pMM1270 | pRPL18B- | 5′ Ura3 homology, | URA3 | KanR | Multigene | This work |
| | Gal4DBD- | pRPL18B-Gal4DBD- | | | | |
| | eMagA- | eMagA-tENO1, | | | | |
| | tENO1, | pRPL18B-eMagBM- | | | | |
| | pRPL18B- | Gal4AD-tENO1, | | | | |
| | eMagBM- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I | | | | | |
| pMM1315 | pHHF1- | ConLS-pHHF1- | | AmpR | Cassette | This work |
| | Gal4DBD- | Gal4DBD-eMagA- | | | | |
| | eMagA | tENO1-ConR1 | | | | |
| pMM1316 | pHHF1- | ConL1-pHHF1- | | AmpR | Cassette | This work |
| | eMagBM- | eMagBM-Gal4AD- | | | | |
| | Gal4AD | tENO1-ConR2 | | | | |
| pMM1317 | pTEF1- | ConL1-pTEF1- | | AmpR | Cassette | This work |
| | eMagBM- | eMagBM-Gal4AD- | | | | |
| | Gal4AD | tENO1-ConR2 | | | | |
| pMM1318 | pHHF1- | ConL1-pHHF1- | | AmpR | Cassette | This work |
| | eMagB- | eMagB-Gal4AD- | | | | |
| | Gal4AD | tENO1-ConR2 | | | | |
| pMM1319 | pRPL18B- | 5′ Ura3 homology, | URA3 | KanR | Multigene | This work |
| | Gal4DBD- | pRPL18B-Gal4DBD- | | | | |
| | eMagA- | eMagA-tENO1, | | | | |
| | tENO1, | pHHF1-eMagBM- | | | | |
| | pHHF1- | Gal4AD-tENO1, | | | | |
| | eMagBM- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I | | | | | |
| pMM1320 | pRPL18B- | 5′ Ura3 homology, | URA3 | KanR | Multigene | This work |
| | Gal4DBD- | pRPL18B-Gal4DBD- | | | | |
| | eMagA- | eMagA-tENO1, | | | | |
| | tENO1, | pTEF1-eMagBM- | | | | |
| | pTEF1- | Gal4AD-tENO1, | | | | |
| | eMagBM- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I | | | | | |
| pMM1321 | pHHF1- | 5′ Ura3 homology, | URA3 | KanR | Multigene | This work |
| | Gal4DBD- | pHHF1-Gal4DBD- | | | | |
| | eMagA- | eMagA-tENO1, | | | | |
| | tENO1, | pHHF1-eMagBM- | | | | |
| | pHHF1- | Gal4AD-tENO1, | | | | |
| | eMagBM- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet- | | | | | |
| pMM1322 | pHHF1- | 5′ Ura3 homology, | URA3 | KanR | Multigene | This work |
| | Gal4DBD- | pHHF1-Gal4DBD- | | | | |
| | eMagA- | eMagA-tENO1, | | | | |
| | tENO1, | pTEF1-eMagBM- | | | | |
| | pTEF1- | Gal4AD-tENO1, | | | | |
| | eMagBM- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I | | | | | |
| pMM1323 | pTEF1- | 5′ Ura3 homology, | URA3 | KanR | Multigene | This work |
| | Gal4DBD- | pTEF1-Gal4DBD- | | | | |
| | eMagA- | eMagA-tENO1, | | | | |
| | tENO1, | pTEF1-eMagBM- | | | | |
| | pTEF1- | Gal4AD-tENO1, | | | | |
| | eMagBM- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I | | | | | |
| pMM1324 | pRPL18B- | 5′ Ura3 homology, | URA3 | KanR | Multigene | This work |
| | Gal4DBD- | pRPL18B-Gal4DBD- | | | | |
| | eMagA- | eMagA-tENO1, | | | | |
| | tENO1, | pHHF1-eMagB- | | | | |
| | pHHF1- | Gal4AD-tENO1, | | | | |
| | eMagB- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I- | | | | | |
| | tENO1 | | | | | |
| pMM1325 | pHHF1- | 5′ Ura3 homology, | URA3 | KanR | Multigene | This work |
| | Gal4DBD- | pHHF1-Gal4DBD- | | | | |
| | eMagA- | eMagA-tENO1, | | | | |
| | tENO1, | pHHF1-eMagB- | | | | |
| | pHHF1- | Gal4AD-tENO1, | | | | |
| | eMagB- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I | | | | | |
| pMM1326 | pHHF1- | 5′ Ura3 homology, | URA3 | KanR | Multigene | This work |
| | Gal4DBD- | pHHF1-Gal4DBD- | | | | |
| | eMagA- | eMagA-tENO1, | | | | |
| | tENO1, | pTEF1-eMagB- | | | | |
| | pTEF1- | Gal4AD-tENO1, | | | | |
| | eMagB- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet-I- | | | | | |
| | tENO1 | | | | | |
| pMM1328 | pRPL18B- | 5′ Ura3 homology, | URA3 | KanR | Multigene | This work |
| | Gal4DBD- | pRPL18B-Gal4DBD- | | | | |
| | eMagAF- | eMagAF-tENO1, | | | | |
| | tENO1, | pRPL18B-eMagB- | | | | |
| | pRPL18B- | Gal4AD-tENO1, | | | | |
| | eMagB- | pGAL1-mScarlet-I- | | | | |
| | Gal4AD- | tENO1, Ura3, Ura 3′ | | | | |
| | tENO1, | homology KanR- | | | | |
| | pGAL1- | ColE1 | | | | |
| | mScarlet | | | | | |
| pRS425- | VVD- | pADH1-VVD-GAL4 | URA3 | AmpR | | Salinas et |
| VVD | GAL4AD | AD-tADH2 | | | | al. 2018 |
| | | | | | | mBio |

TABLE 5
Gene Blocks Used.

| ID | Alias | Sequence | Purpose |
|---|---|---|---|
| gMM035 | Gal4DBD | GCATCGTCTCATCGGTCTCATAT | Domesticated Gal4DBD |
| | | Gaagctactgtcttctatcgaacaagcatgcgatatt | with flanking regions for |
| | | tgccgacttaaaaagctcaagtgctccaaagaaaaa | insertion into a type 3a |
| | | ccgaagtgcgccaagtgtctgaagaacaactggga | yOTK part plasmid |
| | | gtgtcgctactctcccaaaaccaaaaggtcaccgct | (pMM0918) |
| | | gactagggcacatctgacagaagtggaatcaaggc | |
| | | tagaaagactggaacagctatttctactgatttttcctc | |
| | | gagaagaccttgacatgattttgaaaatggattcttta | |
| | | caggatataaaagcattgttaacaggattatttgtaca | |
| | | agataatgtgaataaagatgccgtcacagatagatt | |
| | | ggcttcagtggagactgatatgcctctaacattgaga | |
| | | cagcatagaataagtgcgacatcatcatcggaaga | |
| | | gagtagtaacaaaggtcaaagacagttgactgtatc | |
| | | gggTTCTTGAGACCTGAGACGGC | |
| | | AT | |
| gMM055 | eMagB | gcatCGTCTCaTCGGTCTCAtatggga | Makes eMagB entry part |
| | entry | cataccctctacgcgccggggggttatgacatcatg | 3A with BsmBI digestion |
| | part 3A | ggttacctcagacagatcagaaaccggccgaaccc | |
| | | acaagtggagctgggacccgtcgacctctcctgcg | |
| | | ccctcgtgctgtgtgaccttaagcagaaggacaccc | |
| | | ctgtggtgtacgcctccgaagcattcctggagatga | |
| | | ccgggtacaacagacacgaagtgctgggacggaa | |
| | | ctgccgcttcctgcaatccccggatggaatggtgaa | |
| | | gcctaagtcaacccgcaaatacgtggactccaaca | |
| | | ctatctacaccatgaagaaggccattgaccgcaatg | |
| | | ctgaggtgcaagtggaagtggtgaacttcaagaag | |
| | | aacggacagcgcttcgtcaacttcctgactatgattc | |
| | | ccgtgcgggacgaaaccggcgaataccggtacag | |
| | | catcgggtttcagtgcgagactgagGGCGGT | |
| | | GGCGGCAGTGGTGGAATGAAGC | |
| | | AACTCGAGGACAAGGTTGAGGA | |
| | | ACTGCTGAGTAAGAATTACCAC | |
| | | CTCGAAAACGAGGTCGCACGAT | |
| | | TGAAAAAGTTGGTGGGTGAGgga | |
| | | ggtggtggatcgggtggaggTTCTTGAGA | |
| | | CCtGAGACGgcat | |
| gMM056 | eMagA | gcatCGTCTCaTCGGTCTCAttctggag | Makes eMagA entry part |
| | entry | gcggaggctccggtggtggtggaagtggcggtgg | 3B with BsmBI digestion |
| | part 3B | cggatccatgggacacactctttacgcccctggagg | |
| | | atacgacattatgggatatttggatcagattgcgaac | |
| | | cgcccaaaccctcaggtcgaactggggcctgtgga | |
| | | cctgtcatgtgccctgatcctgtgcgatctgaagcaa | |
| | | aaggacactccgatcgtctacgcctcggaagccttc | |
| | | ttggagatgaccggatacaacagacatgaggtgct | |
| | | cggcaggaactgcagattcctgcagtcccccgacg | |
| | | ggatggtgaaaccaaagtcgactcgcaaatatgtg | |
| | | gactcgaacacgatctacaccatcaagaaggccat | |
| | | cgaccggaacgccgaggtccaggtggaggtggtc | |
| | | aactttaagaagaacggccagcggttcgtgaacttt | |
| | | ctgaccatcattccggtccgggatgaaaccggaga | |
| | | gtacagatactccatcggattccagtgcgaaaccga | |
| | | aTAAatcctGAGACCtGAGACGgcat | |

TABLE 6
Constructs Used.

| Construct | Sequence |
|---|---|
| Gal4DBD- | ATGaagctactgtcttctatcgaacaagcatgcgatatttgccgacttaaaaagctcaagtgctccaaa |
| CRY2(535) | gaaaaaccgaagtgcgccaagtgtctgaagaacaactgggagtgtcgctactctcccaaaaccaaaa |
| | ggtcaccgctgactagggcacatctgacagaagtggaatcaaggctagaaagactggaacagctattt |
| | ctactgatttttcctcgagaagaccttgacatgattttgaaaatggattctttacaggatataaaagcattgtt |
| | aacaggattatttgtacaagataatgtgaataaagatgccgtcacagatagattggcttcagtggagact |
| | gatatgcctctaacattgagacagcatagaataagtgcgacatcatcatcggaagagagtagtaacaaa |
| | ggtcaaagacagttgactgtatcgggTTCTacaggtgctagcttcatgaagatggacaaaaagacta |
| | tagtttggtttagaagagatctaaggattgaggataatcctgcattagcagcagctgctcacgaaggatct |
| | gtttttcctgtcttcatttggtgtcctgaagaagaaggacagttttatcctggaagagcttcaagatggtgg |
| | atgaaacaatcacttgctcacttatctcaatccttgaaggctcttggatctgacctcactttaatcaaaaccc |
| | acaacacgatttcagcgatcttggattgtatccgcgttaccggtgctacaaaagtcgtctttaaccacctct |
| | atgatcctgtttcgttagttcgggaccataccgtaaaggagaagctggtggaacgtgggatctctgtgca |
| | aagctacaatggagatctattgtatgaaccgtgggagatatactgcgaaaagggcaaaccttttacgagt |
| | ttcaattcttactggaagaaatgcttagatatgtcgattgaatccgttatgcttcctcctccttggcggttgat |
| | gccaataactgcagcggctgaagcgatttgggcgtgttcgattgaagaactagggctggagaatgagg |
| | ccgagaaaccgagcaatgcgttgttaactagagcttggagtccaggatggagcaatgctgataagttac |
| | taaatgagttcatcgagaagcagttgatagattatgcaaagaacagcaagaaagttgttgggaattctact |
| | tcactactttctccgtatctccatttcggggaaataagcgtcagacacgttttccagtgtgcccggatgaaa |
| | caaattatatgggcaagagataagaacagtgaaggagaagaaagtgcagatctttttcttaggggaatc |
| | ggtttaagagagtattctcggtatatatgtttcaacttcccgtttactcacgagcaatcgttgttgagtcatctt |
| | cggtttttcccttgggatgctgatgttgataagttcaaggcctggagacaaggcaggaccggttatccgtt |
| | ggtggatgccggaatgagagagctttgggctaccggatggatgcataacagaataagagtgattgtttc |
| | aagctttgctgtgaagtttcttctccttccatggaaatggggaatgaagtatttctgggatacacttttggat |
| | gctgatttggaatgtgacatccttggctggcagtatatctctgggagtatccccgatggccacgagcttg |
| | atcgcttggacaatcccgcgttacaaggcgccaaatatgacccagaaggtgagtacataaggcaatgg |
| | cttcccgagcttgcgagattgccaactgaatggatccatcatccatgggacgctcctttaaccgtactcaa |
| | agcttctggtgtggaactcggaacaaactatgcgaaacccattgtagacatcgacacagctcgtgagct |
| | actagctaaagctatttcaagaacccgtgaagcacagatcatgatcggagcagcacctgatgagattgt |
| | agcagatagcttcgaggccttaggggctaataccattaaagaacctggtctttgcccatctgtgtcttcta |
| | atgaccaacaagtaccttcggctgttGGatcctaa |
| Gal4DBD- | ATGaagctactgtcttctatcgaacaagcatgcgatatttgccgacttaaaaagctcaagtgctccaaa |
| CRY2PHR | gaaaaaccgaagtgcgccaagtgtctgaagaacaactgggagtgtcgctactctcccaaaaccaaaa |
| | ggtcaccgctgactagggcacatctgacagaagtggaatcaaggctagaaagactggaacagctattt |
| | ctactgatttttcctcgagaagaccttgacatgattttgaaaatggattctttacaggatataaaagcattgtt |
| | aacaggattatttgtacaagataatgtgaataaagatgccgtcacagatagattggcttcagtggagact |
| | gatatgcctctaacattgagacagcatagaataagtgcgacatcatcatcggaagagagtagtaacaaa |
| | ggtcaaagacagttgactgtatcgggTTCTacaggtgctagcttcatgaagatggacaaaaagacta |
| | tagtttggtttagaagagatctaaggattgaggataatcctgcattagcagcagctgctcacgaaggatct |
| | gtttttcctgtcttcatttggtgtcctgaagaagaaggacagttttatcctggaagagcttcaagatggtgg |
| | atgaaacaatcacttgctcacttatctcaatccttgaaggctcttggatctgacctcactttaatcaaaaccc |
| | acaacacgatttcagcgatcttggattgtatccgcgttaccggtgctacaaaagtcgtctttaaccacctct |
| | atgatcctgtttcgttagttcgggaccataccgtaaaggagaagctggtggaacgtgggatctctgtgca |
| | aagctacaatggagatctattgtatgaaccgtgggagatatactgcgaaaagggcaaaccttttacgagt |
| | ttcaattcttactggaagaaatgcttagatatgtcgattgaatccgttatgcttcctcctccttggcggttgat |
| | gccaataactgcagcggctgaagcgatttgggcgtgttcgattgaagaactagggctggagaatgagg |
| | ccgagaaaccgagcaatgcgttgttaactagagcttggagtccaggatggagcaatgctgataagttac |
| | taaatgagttcatcgagaagcagttgatagattatgcaaagaacagcaagaaagttgttgggaattctact |
| | tcactactttctccgtatctccatttcggggaaataagcgtcagacacgttttccagtgtgcccggatgaaa |
| | caaattatatgggcaagagataagaacagtgaaggagaagaaagtgcagatctttttcttaggggaatc |
| | ggtttaagagagtattctcggtatatatgtttcaacttcccgtttactcacgagcaatcgttgttgagtcatctt |
| | cggtttttcccttgggatgctgatgttgataagttcaaggcctggagacaaggcaggaccggttatccgtt |
| | ggtggatgccggaatgagagagctttgggctaccggatggatgcataacagaataagagtgattgtttc |
| | aagctttgctgtgaagtttcttctccttccatggaaatggggaatgaagtatttctgggatacacttttggat |
| | gctgatttggaatgtgacatccttggctggcagtatatctctgggagtatccccgatggccacgagcttg |
| | atcgcttggacaatcccgcgttacaaggcgccaaatatgacccagaaggtgagtacataaggcaatgg |
| | cttcccgagcttgcgagattgccaactgaatggatccatcatccatgggacgctcctttaaccgtactcaa |
| | agcttctggtgtggaactcggaacaaactatgcgaaacccattgtagacatcgacacagctcgtgagct |
| | actagctaaagctatttcaagaacccgtgaagcacagatcatgatcggagcagcaGCCCGGGG |
| | atcctaa |
| Gal4DBD- | ATGaagctactgtcttctatcgaacaagcatgcgatatttgccgacttaaaaagctcaagtgctccaaa |
| CRY2FL | gaaaaaccgaagtgcgccaagtgtctgaagaacaactgggagtgtcgctactctcccaaaaccaaaa |
| | ggtcaccgctgactagggcacatctgacagaagtggaatcaaggctagaaagactggaacagctattt |
| | ctactgatttttcctcgagaagaccttgacatgattttgaaaatggattctttacaggatataaaagcattgtt |
| | aacaggattatttgtacaagataatgtgaataaagatgccgtcacagatagattggcttcagtggagact |
| | gatatgcctctaacattgagacagcatagaataagtgcgacatcatcatcggaagagagtagtaacaaa |
| | ggtcaaagacagttgactgtatcgggTTCTacaggtgctagcttcatgaagatggacaaaaagacta |
| | tagtttggtttagaagagatctaaggattgaggataatcctgcattagcagcagctgctcacgaaggatct |
| | gtttttcctgtcttcatttggtgtcctgaagaagaaggacagttttatcctggaagagcttcaagatggtgg |
| | atgaaacaatcacttgctcacttatctcaatccttgaaggctcttggatctgacctcactttaatcaaaaccc |
| | acaacacgatttcagcgatcttggattgtatccgcgttaccggtgctacaaaagtcgtctttaaccacctct |
| | atgatcctgtttcgttagttcgggaccataccgtaaaggagaagctggtggaacgtgggatctctgtgca |
| | aagctacaatggagatctattgtatgaaccgtgggagatatactgcgaaaagggcaaaccttttacgagt |
| | ttcaattcttactggaagaaatgcttagatatgtcgattgaatccgttatgcttcctcctccttggcggttgat |
| | gccaataactgcagcggctgaagcgatttgggcgtgttcgattgaagaactagggctggagaatgagg |
| | ccgagaaaccgagcaatgcgttgttaactagagcttggagtccaggatggagcaatgctgataagttac |
| | taaatgagttcatcgagaagcagttgatagattatgcaaagaacagcaagaaagttgttgggaattctact |
| | tcactactttctccgtatctccatttcggggaaataagcgtcagacacgttttccagtgtgcccggatgaaa |
| | caaattatatgggcaagagataagaacagtgaaggagaagaaagtgcagatctttttcttaggggaatc |
| | ggtttaagagagtattctcggtatatatgtttcaacttcccgtttactcacgagcaatcgttgttgagtcatctt |
| | cggtttttcccttgggatgctgatgttgataagttcaaggcctggagacaaggcaggaccggttatccgtt |
| | ggtggatgccggaatgagagagctttgggctaccggatggatgcataacagaataagagtgattgtttc |
| | aagctttgctgtgaagtttcttctccttccatggaaatggggaatgaagtatttctgggatacacttttggat |
| | gctgatttggaatgtgacatccttggctggcagtatatctctgggagtatccccgatggccacgagcttg |
| | atcgcttggacaatcccgcgttacaaggcgccaaatatgacccagaaggtgagtacataaggcaatgg |
| | cttcccgagcttgcgagattgccaactgaatggatccatcatccatgggacgctcctttaaccgtactcaa |
| | agcttctggtgtggaactcggaacaaactatgcgaaacccattgtagacatcgacacagctcgtgagct |
| | actagctaaagctatttcaagaacccgtgaagcacagatcatgatcggagcagcacctgatgagattgt |
| | agcagatagcttcgaggccttaggggctaataccattaaagaacctggtctttgcccatctgtgtcttcta |
| | atgaccaacaagtaccttcggctgttcgttacaacgggtcaaagagagtgaaacctgaggaagaagaa |
| | gagagagacatgaagaaatctaggggattcgatgaaagggagttgttttcgactgctgaatcttcttcttc |
| | ttcgagtgtgtttttcgtttcgcagtcttgctcgttggcatcagaagggaagaatctggaaggtattcaaga |
| | ttcatctgatcagattactacaagtttgggaaaaaatggttgcaaaGGatcctaa |
| Gal4AD-CIB1 | atggataaagcggaattaattcccgagcctccaaaaaagaagagaaaggtcgaattgggtaccgccg |
| | ccaattttaatcaaagtgggaatattgctgatagctcattgtccttcactttcactaacagtagcaacggtcc |
| | gaacctcataacaactcaaacaaattctcaagcgctttcacaaccaattgcctcctctaacgttcatgataa |
| | cttcatgaataatgaaatcacggctagtaaaattgatgatggtaataattcaaaaccactgtcacctggttg |
| | gacggaccaaactgcgtataacgcgtttggaatcactacagggatgtttaataccactacaatggatgat |
| | gtatataactatctattcgatgatgaagataccccaccaaacccaaaaaaagagatctttaatacgactca |
| | ctatagggcgagcgccgaagctagcgccaccatgaatggagctataggaggtgaccttttgctcaattt |
| | tcctgacatgtcggtcctagagcgccaaagggctcacctcaagtacctcaatcccacctttgattctcctc |
| | tcgccggcttctttgccgattcttcaatgattaccggcggcgagatggacagctatctttcgactgccggt |
| | ttgaatcttccgatgatgtacggtgagacaacggtggaaggtgattcaagactctcaatttcgccggaaa |
| | cgacgcttgggactggaaatttcaagaaacggaagtttgatacagagactaaggattgtaatgagaaga |
| | agaagaagatgacgatgaacagagatgacctagtagaagaaggagaagaagagaagtcgaaaataa |
| | cagagcaaaacaatgggagcacaaaaagcatcaagaagatgaaacacaaagccaagaaagaagag |
| | aacaatttctctaatgattcatctaaagtgacgaaggaattggagaaaacggattatattcatgttcgtgca |
| | cgacgaggccaagccactgatagtcacagcatagcagaacgagttagaagagaaaagatcagtgag |
| | agaatgaagtttctacaagatttggttcctggatgcgacaagatcacaggcaaagcagggatgcttgat |
| | gaaatcattaactatgttcagtctcttcagagacaaatcgagttcttatcgatgaaactagcaattgtgaatc |
| | caaggccggattttgatatggatgacatttttgccaaagaggttgcctcaactccaatgactgtggtgcca |
| | tctcctgaaatggttctttccggttattctcatgagatggttcactctggttattctagtgagatggttaactcc |
| | ggttaccttcatgtcaatccaatgcagcaagtgaataccagttctgatccattgtcatgcttcaacaatggc |
| | gaagctccttcgatgtgggactctcatgtgcagaatctctatggcaatttaggagtaccggtcatcgagct |
| | cgagctgcagatgaatcgtagatacggatcctaa |
| Gal4DBD- | ATGaagctactgtcttctatcgaacaagcatgcgatatttgccgacttaaaaagctcaagtgctccaaa |
| eMagA | gaaaaaccgaagtgcgccaagtgtctgaagaacaactgggagtgtcgctactctcccaaaaccaaaa |
| | ggtcaccgctgactagggcacatctgacagaagtggaatcaaggctagaaagactggaacagctattt |
| | ctactgatttttcctcgagaagaccttgacatgattttgaaaatggattctttacaggatataaaagcattgtt |
| | aacaggattatttgtacaagataatgtgaataaagatgccgtcacagatagattggcttcagtggagact |
| | gatatgcctctaacattgagacagcatagaataagtgcgacatcatcatcggaagagagtagtaacaaa |
| | ggtcaaagacagttgactgtatcgggttctggaggcggaggctccggtggtggtggaagtggcggtg |
| | gcggatccatgggacacactctttacgcccctggaggatacgacattatgggatatttggatcagattgc |
| | gaaccgcccaaaccctcaggtcgaactggggcctgtggacctgtcatgtgccctgatcctgtgcgatct |
| | gaagcaaaaggacactccgategtctacgcctcggaagccttcttggagatgaccggatacaacagac |
| | atgaggtgctcggcaggaactgcagattcctgcagtcccccgacgggatggtgaaaccaaagtcgac |
| | tcgcaaatatgtggactcgaacacgatctacaccatcaagaaggccatcgaccggaacgccgaggtc |
| | caggtggaggtggtcaactttaagaagaacggccagcggttcgtgaactttctgaccatcattccggtc |
| | cgggatgaaaccggagagtacagatactccatcggattccagtgcgaaaccgaaTAA |
| eMagB-Gal4AD | atgggacataccctctacgcgccggggggttatgacatcatgggttacctcagacagatcagaaaccg |
| | gccgaacccacaagtggagctgggacccgtcgacctctcctgcgccctcgtgctgtgtgaccttaagc |
| | agaaggacacccctgtggtgtacgcctccgaagcattcctggagatgaccgggtacaacagacacga |
| | agtgctgggacggaactgccgcttcctgcaatccccggatggaatggtgaagcctaagtcaacccgca |
| | aatacgtggactccaacactatctacaccatgaagaaggccattgaccgcaatgctgaggtgcaagtg |
| | gaagtggtgaacttcaagaagaacggacagcgcttcgtcaacttcctgactatgattcccgtgcgggac |
| | gaaaccggcgaataccggtacagcatcgggtttcagtgcgagactgagGGCGGTGGCGGC |
| | AGTGGTGGAATGAAGCAACTCGAGGACAAGGTTGAGGAACTG |
| | CTGAGTAAGAATTACCACCTCGAAAACGAGGTCGCACGATTG |
| | AAAAAGTTGGTGGGTGAGggaggtggtggatcgggtggaggTTCTGATAA |
| | AGCGGAATTAATTCCCGAGCCTCCAAAAAAGAAGAGAAAGGT |
| | CGAATTGGGTACCGCCGCCAATTTTAATCAAAGTGGGAATATT |
| | GCTGATAGCTCATTGTCCTTCACTTTCACTAACAGTAGCAACG |
| | GTCCGAACCTCATAACAACTCAAACAAATTCTCAAGCGCTTTC |
| | ACAACCAATTGCCTCCTCTAACGTTCATGATAACTTCATGAAT |
| | AATGAAATCACGGCTAGTAAAATTGATGATGGTAATAATTCA |
| | AAACCACTGTCACCTGGTTGGACGGACCAAACTGCGTATAAC |
| | GCGTTTGGAATCACTACAGGGATGTTTAATACCACTACAATGG |
| | ATGATGTATATAACTATCTATTCGATGATGAAGATACCCCACC |
| | AAACCCAAAAAAAGAGtaa |
| Gal4DBD- | ATGaagctactgtcttctatcgaacaagcatgcgatatttgccgacttaaaaagctcaagtgctccaaa |
| eMagAF | gaaaaaccgaagtgcgccaagtgtctgaagaacaactgggagtgtcgctactctcccaaaaccaaaa |
| | ggtcaccgctgactagggcacatctgacagaagtggaatcaaggctagaaagactggaacagctattt |
| | ctactgatttttcctcgagaagaccttgacatgattttgaaaatggattctttacaggatataaaagcattgtt |
| | aacaggattatttgtacaagataatgtgaataaagatgccgtcacagatagattggcttcagtggagact |
| | gatatgcctctaacattgagacagcatagaataagtgcgacatcatcatcggaagagagtagtaacaaa |
| | ggtcaaagacagttgactgtatcgggttctggaggcggaggctccggtggtggtggaagtggcggtg |
| | gcggatccatgggacacactctttacgcccctggaggatacgacattatgggatatttggatcagattgc |
| | gaaccgcccaaaccctcaggtcgaactggggcctgtggacctgtcatgtgccctgatcctgtgcgatct |
| | gaagcaaaaggacactccgatcgtctacgcctcggaagccttcttggagatgaccggatacaacagac |
| | atgaggtgctcggcaggaactgcagattcctgcagtcccccgacgggatggtgaaaccaaagtcgac |
| | tcgcaaatatgtggactcgaacacgatcttcaccatcaagaaggccatcgaccggaacgccgaggtcc |
| | aggtggaggtggtcaactttaagaagaacggccagcggttcgtgaactttctgaccatcattccggtcc |
| | gggatgaaaccggagagtacagatactccatcggattccagtgcgaaaccgaaTAA |
| eMagBF- | atgggacataccctctacgcgccggggggttatgacatcatgggttacctcagacagatcagaaaccg |
| Gal4AD | gccgaacccacaagtggagctgggacccgtcgacctctcctgcgccctcgtgctgtgtgaccttaagc |
| | agaaggacacccctgtggtgtacgcctccgaagcattcctggagatgaccgggtacaacagacacga |
| | agtgctgggacggaactgccgcttcctgcaatccccggatggaatggtgaagcctaagtcaacccgca |
| | aatacgtggactccaacactatcttcaccatgaagaaggccattgaccgcaatgctgaggtgcaagtgg |
| | aagtggtgaacttcaagaagaacggacagcgcttcgtcaacttcctgactatgattcccgtgcgggacg |
| | aaaccggcgaataccggtacagcatcgggtttcagtgcgagactgagGGCGGTGGCGGC |
| | AGTGGTGGAATGAAGCAACTCGAGGACAAGGTTGAGGAACTG |
| | CTGAGTAAGAATTACCACCTCGAAAACGAGGTCGCACGATTG |
| | AAAAAGTTGGTGGGTGAGggaggtggtggatcgggtggaggTTCTGATAA |
| | AGCGGAATTAATTCCCGAGCCTCCAAAAAAGAAGAGAAAGGT |
| | CGAATTGGGTACCGCCGCCAATTTTAATCAAAGTGGGAATATT |
| | GCTGATAGCTCATTGTCCTTCACTTTCACTAACAGTAGCAACG |
| | GTCCGAACCTCATAACAACTCAAACAAATTCTCAAGCGCTTTC |
| | ACAACCAATTGCCTCCTCTAACGTTCATGATAACTTCATGAAT |
| | AATGAAATCACGGCTAGTAAAATTGATGATGGTAATAATTCA |
| | AAACCACTGTCACCTGGTTGGACGGACCAAACTGCGTATAAC |
| | GCGTTTGGAATCACTACAGGGATGTTTAATACCACTACAATGG |
| | ATGATGTATATAACTATCTATTCGATGATGAAGATACCCCACC |
| | AAACCCAAAAAAAGAGtaa |
| eMagBM- | atgggacataccctctacgcgccggggggttatgacatcatgggttacctcagacagatcagaaaccg |
| Gal4AD | gccgaacccacaagtggagctgggacccgtcgacctctcctgcgccctcatcctgtgtgaccttaagc |
| | agaaggacacccctgtggtgtacgcctccgaagcattcctggagatgaccgggtacaacagacacga |
| | agtgctgggacggaactgccgcttcctgcaatccccggatggaatggtgaagcctaagtcaacccgca |
| | aatacgtggactccaacactatctacaccatgaagaaggccattgaccgcaatgctgaggtgcaagtg |
| | gaagtggtgaacttcaagaagaacggacagcgcttcgtcaacttcctgactatgattcccgtgcgggac |
| | gaaaccggcgaataccggtacagcatcgggtttcagtgcgagactgagGGCGGTGGCGGC |
| | AGTGGTGGAATGAAGCAACTCGAGGACAAGGTTGAGGAACTG |
| | CTGAGTAAGAATTACCACCTCGAAAACGAGGTCGCACGATTG |
| | AAAAAGTTGGTGGGTGAGggaggtggtggatcgggtggaggTTCTGATAA |
| | AGCGGAATTAATTCCCGAGCCTCCAAAAAAGAAGAGAAAGGT |
| | CGAATTGGGTACCGCCGCCAATTTTAATCAAAGTGGGAATATT |
| | GCTGATAGCTCATTGTCCTTCACTTTCACTAACAGTAGCAACG |
| | GTCCGAACCTCATAACAACTCAAACAAATTCTCAAGCGCTTTC |
| | ACAACCAATTGCCTCCTCTAACGTTCATGATAACTTCATGAAT |
| | AATGAAATCACGGCTAGTAAAATTGATGATGGTAATAATTCA |
| | AAACCACTGTCACCTGGTTGGACGGACCAAACTGCGTATAAC |
| | GCGTTTGGAATCACTACAGGGATGTTTAATACCACTACAATGG |
| | ATGATGTATATAACTATCTATTCGATGATGAAGATACCCCACC |
| | AAACCCAAAAAAAGAGtaa |

### OptoPlate Configuration and Calibration

The optoPlate for light induction was constructed and calibrated according to previously published methods. Re-calibration of the optoPlate was found to be necessary for consistent illumination since the time of its initial calibration by Groodem et al., 2020 BioTechniques, 69: 313-316 (possibly due to decay of the LEDs). An intensity of 125 μW/cm² was used for all experiments except where otherwise specified.

Automated characterization of optogenetic systems on the Tecan Fluent Automation Workstation and Spark plate reader

Automated experiments were carried out on a Tecan Fluent Automation Workstation, programmed using the Tecan Fluent Control visual interface software. The Fluent was equipped with an optoPlate, BioShake 3000-T elm heater shaker for well plates, a Tecan Spark plate reader, and a Robotic Gripper Arm (RGA) for moving plates and plate lids. The Fluent was covered with a blackout curtain for the duration of experiments to prevent ambient light. Experiments were done using Cellvis 96-well glass bottom plates with #1.5 cover glass (Cat. #P96-1.5H-N). Plates were covered with a lid for all experiments except for those measuring the photoactivation effect of mRuby2. For experiments measuring the photoactivation effect of mRuby2, the plate was covered in a Breathe-Easy polyurethane sealing membrane (Diversified Biotech, BEM-1) because these conditions created a stronger light-induced fluorescent signal. Each 96-well plate with culture diluted to OD700=0.1 was incubated for 5 hours in the dark at 30° C., shaking, before beginning light induction. For each light induction experiment, the plate was placed on the optoPlate for 26.5 minutes at 21° C., transferred to the BioShake to shake at 1000 rpm (2 mm orbital) for 1 minute, and then transferred to the Tecan Spark plate reader to read optical density and fluorescence (with the lid temporarily removed by the Robotic Gripper Arm to ensure accurate OD readings). The plate was then transferred back to the optoPlate, and this cycle was repeated over the course of the experiment. Optical density was measured at 700 nm to avoid bias from measuring red fluorescent mScarlet-I. For mScarlet-I, fluorescence was measured with excitation at 563 nm and emission at 606 nm, with Z=28410, and an optical gain of 130.

### Data Analysis

Error bars shown represent the standard error of sample means performed in technical triplicate. Fold change shown is the raw fluorescence value of the induced strain divided by the raw fluorescence of the dark control. Exponential decay of mRuby2 photoactivation measurements (FIGS. 12A-12C) were fit to the decay curve y=a·e−b·x+c using the curve_fit function from the scipy.optimize package in Python.

### Aspects

The following Aspects are illustrative only and do not limit the scope of the present disclosure or the appended claims. Any part or parts of any one or more Aspects can be combined with any part or parts of any one or more other Aspects.

Aspect 1. An automated optogenetics system, comprising: an illumination element configured to apply an illumination program to at least one discrete region of a cell container; a shaker element configured to shake the cell container; a detector element, configured for measuring at least one of optical density, bioluminescence, fluorescence, and absorbance from the at least one discrete region; and optionally, a transfer element configured to transfer the cell container, during an experiment, between any two or more of the illumination element, the shaker element, and the detector element.

Aspect 2. The system of Aspect 1, wherein an illumination program comprises at least one of: one or more light intensities, one or more light duty cycles, one or more light pulse durations, and one or more light pulse frequencies.

Aspect 3. The system of any one of Aspects 1-2, wherein an illumination program comprises one or more on/off sequences of illumination at one or more light intensities and/or at one or more wavelengths of light.

Aspect 4. The system of any one of Aspects 1-3, wherein the illumination element is configured to apply a first illumination program to a first discrete region of the cell container and a second illumination program to a second discrete region of the cell container, the first illumination program and the second illumination program differing from one another.

Aspect 5. The system of any one of Aspects 1-4, wherein the shaker element comprises a temperature controller configured to maintain a temperature of the cell container while the cell container is associated with the shaker element.

Aspect 6. The system of any one of Aspects 1-5, wherein a discrete region comprises a well in a multi-well plate, the multi-well plate optionally being a 96-well plate.

Aspect 7. The system of any one of Aspects 1-6, further comprising one or more fluid handling elements.

Aspect 8. The system of Aspect 7, wherein the fluid handling element is configured to collect a fluid sample from the at least one discrete region of the cell container following application of the illumination program to the at least one discrete region of the cell container.

Aspect 9. The system of Aspect 8, wherein the collected fluid is assayed using a detector configured to measure one or more of absorbance, optical density, bioluminescence, and fluorescence.

Aspect 10. The system of Aspect 7, wherein the fluid handling element is configured to deposit a fluid sample into at least one discrete region of the cell container.

Aspect 11. The system of Aspect 10, wherein the deposited fluid sample comprises cell culture media.

Aspect 12. The system of any one of Aspects 1-11, wherein the system is configured to measure at least one of optical density, absorbance, bioluminescence and fluorescence from the discrete region at one or more time points during an experiment.

Aspect 13. A process for performing optogenetics, comprising: placing a cell container loaded with one or more biological samples onto a shaker element; performing a shaking program on the cell container with the shaker element; illuminating, in accordance with an illumination program, one or more discrete regions of the cell container; and detecting, using a detector element, one or more signals associated with one or more discrete regions of the sample plate.

Aspect 14. The process of Aspect 13, wherein the detecting is performed intermittently over a time course.

Aspect 15. The process of any one of Aspects 13-14, further comprising determining, based on the detected signal, an activation state of one or more biological pathways of the biological sample.

Aspect 16. The process of Aspect 15, wherein the activation state comprises at least one of an elevated expression of one or more proteins, modulation of one or more ion channels, and/or modulation of one or more signaling pathways relative to a comparator control.

Aspect 17. The process of Aspect 15, wherein the one or more biological pathways comprise one or more light-sensitive cellular pathways.

Aspect 18. The process of any one of Aspects 13-17, further comprising collecting a fluid sample from the one or more discrete regions of the cell container following application of the illumination program to the one or more discrete regions of the cell container.

Aspect 19. The process of Aspect 18, wherein the collected fluid is assayed using a detector configured to measure one or more of absorbance, optical density, bioluminescence, and fluorescence.

Aspect 20. The process of any one of Aspects 12-19, further comprising depositing a fluid sample into one or more discrete regions of the cell container.

Aspect 21. A method for selecting an illumination program, comprising: applying a first illumination program to a biological sample, the first illumination program comprising a first combination of one or more light intensities, one or more light duty cycles, one or more light pulse durations, and one or more light pulse frequencies; detecting one or more signals from the biological sample; determining, from the one or more detected signals, an activation state of one or more biological pathways of the biological sample; based on the detected signal, (i) continuing to apply the first illumination program to the biological sample for a duration of time or (ii) applying a second illumination program to the biological sample; and repeating steps b) to d) until a selected activation state of the biological sample is obtained.

Aspect 22. The method of Aspect 21, wherein the biological sample comprises one or more of yeast cells, bacterial cells, and mammalian cells.

Aspect 23. The method of any one of Aspects 21-22, wherein a detected signal comprises one or more of an optical density, an absorbance, a bioluminescence, a fluorescence, or a combination thereof.

Aspect 24. The method of any one of Aspects 21-23, wherein the one or more light intensities comprise from about 0.1 μW/cm² to about 200 μW/cm².

Aspect 25. The method of any one of Aspects 21-24, wherein at least one light pulse duration is from about 0.5 second to about 120 seconds.

Aspect 26. The method of any one of Aspects 21-25, wherein at least one light pulse duration is from about 1 minute to about 240 minutes.

Aspect 27. The method of any one of Aspects 21-26, wherein at least one light duty cycle is from about 5% to about 100%.

Aspect 28. The method of any one of Aspects 21-27, wherein at least one light pulse frequency is from about 0.5 Hz to about 5 Hz.

Aspect 29. The method of any one of Aspects 21-28, wherein the selected activation state is defined by one or more detected signal values associated with the selected activation state.

Aspect 30. The method of any one of Aspects 21-29, wherein the selected activation state is defined by one or more characteristics of a fluid collected from the biological sample.

Aspect 31. The method of Aspect 30, wherein the one or more characteristics of the collected fluid comprise any one or more of a pH value and a concentration of one or more solutes in the biological sample.

Aspect 32. The method of any one of Aspects 21-31, wherein the first illumination program and the second illumination program differ in terms of one or more of a light intensity, a light duty cycle, a pulse duration, a light pulse periodicity, and a light pulse frequency.

What is claimed:

1. An automated optogenetics system, comprising:
an illumination element configured to apply an illumination program to at least one discrete region of a cell container;
a shaker element configured to shake the cell container;
a detector element, configured for measuring at least one of optical density, bioluminescence, fluorescence, and absorbance from the at least one discrete region; and
optionally, a transfer element configured to transfer the cell container, during an experiment, between any two or more of the illumination element, the shaker element, and the detector element.

2. The system of claim 1, wherein an illumination program comprises at least one of:
one or more light intensities, one or more light duty cycles, one or more light pulse durations, and one or more light pulse frequencies.

3. The system of claim 1, wherein an illumination program comprises one or more on/off sequences of illumination at one or more light intensities and/or at one or more wavelengths of light.

4. The system of claim 1, wherein the illumination element is configured to apply a first illumination program to a first discrete region of the cell container and a second illumination program to a second discrete region of the cell container, the first illumination program and the second illumination program differing from one another.

5. The system of claim 1, wherein the shaker element comprises a temperature controller configured to maintain a temperature of the cell container while the cell container is associated with the shaker element.

6. The system of claim 1, further comprising one or more fluid handling elements configured to collect a fluid sample from the at least one discrete region of the cell container following application of the illumination program to the at least one discrete region of the cell container.

7. The system of claim 6, wherein the fluid handling element is configured to deposit a fluid sample into at least one discrete region of the cell container.

8. The system of claim 1, wherein the system is configured to measure at least one of optical density, absorbance, bioluminescence and fluorescence from the discrete region at one or more time points during an experiment.

9. A process for performing optogenetics, comprising:
placing a cell container loaded with one or more biological samples onto a shaker element;
performing a shaking program on the cell container with the shaker element;
illuminating, in accordance with an illumination program, one or more discrete regions of the cell container; and
detecting, using a detector element, one or more signals associated with one or more discrete regions of the sample plate.

10. The process of claim 9, further comprising determining, based on the detected signal, an activation state of one or more biological pathways of the biological sample, wherein the activation state comprises at least one of an elevated expression of one or more proteins, modulation of one or more ion channels, and/or modulation of one or more signaling pathways relative to a comparator control, and wherein the one or more biological pathways comprise one or more light-sensitive cellular pathways.

11. The process of claim 9, further comprising collecting a fluid sample from the one or more discrete regions of the cell container following application of the illumination program to the one or more discrete regions of the cell container.

12. The process of claim 9, further comprising depositing a fluid sample into one or more discrete regions of the cell container.

13. A method for selecting an illumination program, comprising:
a) applying a first illumination program to a biological sample, the first illumination program comprising a first combination of one or more light intensities, one or more light duty cycles, one or more light pulse durations, and one or more light pulse frequencies;
b) detecting one or more signals from the biological sample;
c) determining, from the one or more detected signals, an activation state of one or more biological pathways of the biological sample;
d) based on the detected signal, (i) continuing to apply the first illumination program to the biological sample for a duration of time or (ii) applying a second illumination program to the biological sample; and
e) repeating steps b) to d) until a selected activation state of the biological sample is obtained.

14. The method of claim 13, wherein a detected signal comprises one or more of an optical density, an absorbance, a bioluminescence, a fluorescence, or a combination thereof.

15. The method of claim 13, wherein the one or more light intensities comprise from about 0.1 μW/cm² to about 200 μW/cm².

16. The method of claim 13, wherein at least one light pulse duration is from about 0.5 second to about 120 seconds.

17. The method of claim 13, wherein at least one light duty cycle is from about 5% to about 100%.

18. The method of claim 13, wherein at least one light pulse frequency is from about 0.5 Hz to about 5 Hz.

19. The method of claim 13, wherein the selected activation state is defined by one or more characteristics of a fluid collected from the biological sample wherein the one or more characteristics of the collected fluid comprise any one or more of a pH value and a concentration of one or more solutes in the biological sample.

20. The method of claim 13, wherein the first illumination program and the second illumination program differ in terms of one or more of a light intensity, a light duty cycle, a pulse duration, a light pulse periodicity, and a light pulse frequency.


SEQUENCE LISTING (32 sequences)

SEQ ID NO: 1 - DNA, 45 bp, synthetic construct
  source 1..45: mol_type = other DNA
gcatcgtctcatcggtctcatatggataaagcggaattaattccc

SEQ ID NO: 2 - DNA, 46 bp, synthetic construct
  source 1..46: mol_type = other DNA
atgccgtctcaggtctcaggatccgtatctacgattcatctgcagc

SEQ ID NO: 3 - DNA, 43 bp, synthetic construct
  source 1..43: mol_type = other DNA
gcatcgtctcatcggtctcatatgaagctactgtcttctatcg

SEQ ID NO: 4 - DNA, 45 bp, synthetic construct
  source 1..45: mol_type = other DNA
atgccgtctcaggtctcaagaacccgatacagtcaactgtctttg

SEQ ID NO: 5 - DNA, 42 bp, synthetic construct
  source 1..42: mol_type = other DNA
gcatcgtctcatcggtctcattctacaggtgctagcttcatg

SEQ ID NO: 6 - DNA, 42 bp, synthetic construct
  source 1..42: mol_type = other DNA
atgccgtctcaggtctcaggatccaacagccgaaggtacttg

SEQ ID NO: 7 - DNA, 41 bp, synthetic construct
  source 1..41: mol_type = other DNA
gcatcgtctcatcggtctcatatgagccataccgtgaactc

SEQ ID NO: 8 - DNA, 45 bp, synthetic construct
  source 1..45: mol_type = other DNA
atgccgtctcaggtctcaggatcctgaaccagcgtaatctggtac

SEQ ID NO: 9 - DNA, 43 bp, synthetic construct
  source 1..43: mol_type = other DNA
gcatcgtctcatcggtctcatatgatggtaagcaaaggtgagg

SEQ ID NO: 10 - DNA, 46 bp, synthetic construct
  source 1..46: mol_type = other DNA
atgccgtctcaggtctcaggatctacttatataattcgtccatgcc

SEQ ID NO: 11 - DNA, 46 bp, synthetic construct
  source 1..46: mol_type = other DNA
gcatcgtctcatcggtctcattctgataaagcggaattaattcccg

SEQ ID NO: 12 - DNA, 46 bp, synthetic construct
  source 1..46: mol_type = other DNA
atgccgtctcaggtctcaggatttactctttttttgggtttggtgg

SEQ ID NO: 13 - DNA, 25 bp, synthetic construct
  source 1..25: mol_type = other DNA
aacactatcttcaccatgaagaagg

SEQ ID NO: 14 - DNA, 18 bp, synthetic construct
  source 1..18: mol_type = other DNA
ggagtccacgtatttgcg

SEQ ID NO: 15 - DNA, 21 bp, synthetic construct
  source 1..21: mol_type = other DNA
aacacgatcttcaccatcaag

SEQ ID NO: 16 - DNA, 18 bp, synthetic construct
  source 1..18: mol_type = other DNA
cgagtccacatatttgcg

SEQ ID NO: 17 - DNA, 21 bp, synthetic construct
  source 1..21: mol_type = other DNA
ggcgaataccggtacagcatc

SEQ ID NO: 18 - DNA, 51 bp, synthetic construct
  source 1..51: mol_type = other DNA
aggggtgtccttctgcttaaggtcacacaggatgagggcgcaggagaggtc

SEQ ID NO: 19 - DNA, 23 bp, synthetic construct
  source 1..23: mol_type = other DNA
ttaagcagaaggacacccctgtg

SEQ ID NO: 20 - DNA, 21 bp, synthetic construct
  source 1..21: mol_type = other DNA
gatgctgtaccggtattcgcc

SEQ ID NO: 21 - DNA, 486 bp, synthetic construct
  source 1..486: mol_type = other DNA
gcatcgtctcatcggtctcatatgaagctactgtcttctatcgaacaagcatgcgatatttgccgacttaaaaagctcaagtgctccaaagaaaaaccgaagtgcgccaagtgtctgaagaacaactgggagtgtcgctactctcccaaaaccaaaaggtcaccgctgactagggcacatctgacagaagtggaatcaaggctagaaagactggaacagctatttctactgatttttcctcgagaagaccttgacatgattttgaaaatggattctttacaggatataaaagcattgttaacaggattatttgtacaagataatgtgaataaagatgccgtcacagatagattggcttcagtggagactgatatgcctctaacattgagacagcatagaataagtgcgacatcatcatcggaagagagtagtaacaaaggtcaaagacagttgactgtatcgggttcttgagacctgagacggcat

SEQ ID NO: 22 - DNA, 636 bp, synthetic construct
  source 1..636: mol_type = other DNA
gcatcgtctcatcggtctcatatgggacataccctctacgcgccggggggttatgacatcatgggttacctcagacagatcagaaaccggccgaacccacaagtggagctgggacccgtcgacctctcctgcgccctcgtgctgtgtgaccttaagcagaaggacacccctgtggtgtacgcctccgaagcattcctggagatgaccgggtacaacagacacgaagtgctgggacggaactgccgcttcctgcaatccccggatggaatggtgaagcctaagtcaacccgcaaatacgtggactccaacactatctacaccatgaagaaggccattgaccgcaatgctgaggtgcaagtggaagtggtgaacttcaagaagaacggacagcgcttcgtcaacttcctgactatgattcccgtgcgggacgaaaccggcgaataccggtacagcatcgggtttcagtgcgagactgagggcggtggcggcagtggtggaatgaagcaactcgaggacaaggttgaggaactgctgagtaagaattaccacctcgaaaacgaggtcgcacgattgaaaaagttggtgggtgagggaggtggtggatcgggtggaggttcttgagacctgagacggcat

SEQ ID NO: 23 - DNA, 550 bp, synthetic construct
  source 1..550: mol_type = other DNA
gcatcgtctcatcggtctcattctggaggcggaggctccggtggtggtggaagtggcggtggcggatccatgggacacactctttacgcccctggaggatacgacattatgggatatttggatcagattgcgaaccgcccaaaccctcaggtcgaactggggcctgtggacctgtcatgtgccctgatcctgtgcgatctgaagcaaaaggacactccgatcgtctacgcctcggaagccttcttggagatgaccggatacaacagacatgaggtgctcggcaggaactgcagattcctgcagtcccccgacgggatggtgaaaccaaagtcgactcgcaaatatgtggactcgaacacgatctacaccatcaagaaggccatcgaccggaacgccgaggtccaggtggaggtggtcaactttaagaagaacggccagcggttcgtgaactttctgaccatcattccggtccgggatgaaaccggagagtacagatactccatcggattccagtgcgaaaccgaataaatcctgagacctgagacggcat

SEQ ID NO: 24 - DNA, 2076 bp, synthetic construct
  source 1..2076: mol_type = other DNA
atgaagctactgtcttctatcgaacaagcatgcgatatttgccgacttaaaaagctcaagtgctccaaagaaaaaccgaagtgcgccaagtgtctgaagaacaactgggagtgtcgctactctcccaaaaccaaaaggtcaccgctgactagggcacatctgacagaagtggaatcaaggctagaaagactggaacagctatttctactgatttttcctcgagaagaccttgacatgattttgaaaatggattctttacaggatataaaagcattgttaacaggattatttgtacaagataatgtgaataaagatgccgtcacagatagattggcttcagtggagactgatatgcctctaacattgagacagcatagaataagtgcgacatcatcatcggaagagagtagtaacaaaggtcaaagacagttgactgtatcgggttctacaggtgctagcttcatgaagatggacaaaaagactatagtttggtttagaagagatctaaggattgaggataatcctgcattagcagcagctgctcacgaaggatctgtttttcctgtcttcatttggtgtcctgaagaagaaggacagttttatcctggaagagcttcaagatggtggatgaaacaatcacttgctcacttatctcaatccttgaaggctcttggatctgacctcactttaatcaaaacccacaacacgatttcagcgatcttggattgtatccgcgttaccggtgctacaaaagtcgtctttaaccacctctatgatcctgtttcgttagttcgggaccataccgtaaaggagaagctggtggaacgtgggatctctgtgcaaagctacaatggagatctattgtatgaaccgtgggagatatactgcgaaaagggcaaaccttttacgagtttcaattcttactggaagaaatgcttagatatgtcgattgaatccgttatgcttcctcctccttggcggttgatgccaataactgcagcggctgaagcgatttgggcgtgttcgattgaagaactagggctggagaatgaggccgagaaaccgagcaatgcgttgttaactagagcttggagtccaggatggagcaatgctgataagttactaaatgagttcatcgagaagcagttgatagattatgcaaagaacagcaagaaagttgttgggaattctacttcactactttctccgtatctccatttcggggaaataagcgtcagacacgttttccagtgtgcccggatgaaacaaattatatgggcaagagataagaacagtgaaggagaagaaagtgcagatctttttcttaggggaatcggtttaagagagtattctcggtatatatgtttcaacttcccgtttactcacgagcaatcgttgttgagtcatcttcggtttttcccttgggatgctgatgttgataagttcaaggcctggagacaaggcaggaccggttatccgttggtggatgccggaatgagagagctttgggctaccggatggatgcataacagaataagagtgattgtttcaagctttgctgtgaagtttcttctccttccatggaaatggggaatgaagtatttctgggatacacttttggatgctgatttggaatgtgacatccttggctggcagtatatctctgggagtatccccgatggccacgagcttgatcgcttggacaatcccgcgttacaaggcgccaaatatgacccagaaggtgagtacataaggcaatggcttcccgagcttgcgagattgccaactgaatggatccatcatccatgggacgctcctttaaccgtactcaaagcttctggtgtggaactcggaacaaactatgcgaaacccattgtagacatcgacacagctcgtgagctactagctaaagctatttcaagaacccgtgaagcacagatcatgatcggagcagcacctgatgagattgtagcagatagcttcgaggccttaggggctaataccattaaagaacctggtctttgcccatctgtgtcttctaatgaccaacaagtaccttcggctgttggatcctaa

SEQ ID NO: 25 - DNA, 1971 bp, synthetic construct
  source 1..1971: mol_type = other DNA
atgaagctactgtcttctatcgaacaagcatgcgatatttgccgacttaaaaagctcaagtgctccaaagaaaaaccgaagtgcgccaagtgtctgaagaacaactgggagtgtcgctactctcccaaaaccaaaaggtcaccgctgactagggcacatctgacagaagtggaatcaaggctagaaagactggaacagctatttctactgatttttcctcgagaagaccttgacatgattttgaaaatggattctttacaggatataaaagcattgttaacaggattatttgtacaagataatgtgaataaagatgccgtcacagatagattggcttcagtggagactgatatgcctctaacattgagacagcatagaataagtgcgacatcatcatcggaagagagtagtaacaaaggtcaaagacagttgactgtatcgggttctacaggtgctagcttcatgaagatggacaaaaagactatagtttggtttagaagagatctaaggattgaggataatcctgcattagcagcagctgctcacgaaggatctgtttttcctgtcttcatttggtgtcctgaagaagaaggacagttttatcctggaagagcttcaagatggtggatgaaacaatcacttgctcacttatctcaatccttgaaggctcttggatctgacctcactttaatcaaaacccacaacacgatttcagcgatcttggattgtatccgcgttaccggtgctacaaaagtcgtctttaaccacctctatgatcctgtttcgttagttcgggaccataccgtaaaggagaagctggtggaacgtgggatctctgtgcaaagctacaatggagatctattgtatgaaccgtgggagatatactgcgaaaagggcaaaccttttacgagtttcaattcttactggaagaaatgcttagatatgtcgattgaatccgttatgcttcctcctccttggcggttgatgccaataactgcagcggctgaagcgatttgggcgtgttcgattgaagaactagggctggagaatgaggccgagaaaccgagcaatgcgttgttaactagagcttggagtccaggatggagcaatgctgataagttactaaatgagttcatcgagaagcagttgatagattatgcaaagaacagcaagaaagttgttgggaattctacttcactactttctccgtatctccatttcggggaaataagcgtcagacacgttttccagtgtgcccggatgaaacaaattatatgggcaagagataagaacagtgaaggagaagaaagtgcagatctttttcttaggggaatcggtttaagagagtattctcggtatatatgtttcaacttcccgtttactcacgagcaatcgttgttgagtcatcttcggtttttcccttgggatgctgatgttgataagttcaaggcctggagacaaggcaggaccggttatccgttggtggatgccggaatgagagagctttgggctaccggatggatgcataacagaataagagtgattgtttcaagctttgctgtgaagtttcttctccttccatggaaatggggaatgaagtatttctgggatacacttttggatgctgatttggaatgtgacatccttggctggcagtatatctctgggagtatccccgatggccacgagcttgatcgcttggacaatcccgcgttacaaggcgccaaatatgacccagaaggtgagtacataaggcaatggcttcccgagcttgcgagattgccaactgaatggatccatcatccatgggacgctcctttaaccgtactcaaagcttctggtgtggaactcggaacaaactatgcgaaacccattgtagacatcgacacagctcgtgagctactagctaaagctatttcaagaacccgtgaagcacagatcatgatcggagcagcagcccggggatcctaa

SEQ ID NO: 26 - DNA, 2307 bp, synthetic construct
  source 1..2307: mol_type = other DNA
atgaagctactgtcttctatcgaacaagcatgcgatatttgccgacttaaaaagctcaagtgctccaaagaaaaaccgaagtgcgccaagtgtctgaagaacaactgggagtgtcgctactctcccaaaaccaaaaggtcaccgctgactagggcacatctgacagaagtggaatcaaggctagaaagactggaacagctatttctactgatttttcctcgagaagaccttgacatgattttgaaaatggattctttacaggatataaaagcattgttaacaggattatttgtacaagataatgtgaataaagatgccgtcacagatagattggcttcagtggagactgatatgcctctaacattgagacagcatagaataagtgcgacatcatcatcggaagagagtagtaacaaaggtcaaagacagttgactgtatcgggttctacaggtgctagcttcatgaagatggacaaaaagactatagtttggtttagaagagatctaaggattgaggataatcctgcattagcagcagctgctcacgaaggatctgtttttcctgtcttcatttggtgtcctgaagaagaaggacagttttatcctggaagagcttcaagatggtggatgaaacaatcacttgctcacttatctcaatccttgaaggctcttggatctgacctcactttaatcaaaacccacaacacgatttcagcgatcttggattgtatccgcgttaccggtgctacaaaagtcgtctttaaccacctctatgatcctgtttcgttagttcgggaccataccgtaaaggagaagctggtggaacgtgggatctctgtgcaaagctacaatggagatctattgtatgaaccgtgggagatatactgcgaaaagggcaaaccttttacgagtttcaattcttactggaagaaatgcttagatatgtcgattgaatccgttatgcttcctcctccttggcggttgatgccaataactgcagcggctgaagcgatttgggcgtgttcgattgaagaactagggctggagaatgaggccgagaaaccgagcaatgcgttgttaactagagcttggagtccaggatggagcaatgctgataagttactaaatgagttcatcgagaagcagttgatagattatgcaaagaacagcaagaaagttgttgggaattctacttcactactttctccgtatctccatttcggggaaataagcgtcagacacgttttccagtgtgcccggatgaaacaaattatatgggcaagagataagaacagtgaaggagaagaaagtgcagatctttttcttaggggaatcggtttaagagagtattctcggtatatatgtttcaacttcccgtttactcacgagcaatcgttgttgagtcatcttcggtttttcccttgggatgctgatgttgataagttcaaggcctggagacaaggcaggaccggttatccgttggtggatgccggaatgagagagctttgggctaccggatggatgcataacagaataagagtgattgtttcaagctttgctgtgaagtttcttctccttccatggaaatggggaatgaagtatttctgggatacacttttggatgctgatttggaatgtgacatccttggctggcagtatatctctgggagtatccccgatggccacgagcttgatcgcttggacaatcccgcgttacaaggcgccaaatatgacccagaaggtgagtacataaggcaatggcttcccgagcttgcgagattgccaactgaatggatccatcatccatgggacgctcctttaaccgtactcaaagcttctggtgtggaactcggaacaaactatgcgaaacccattgtagacatcgacacagctcgtgagctactagctaaagctatttcaagaacccgtgaagcacagatcatgatcggagcagcacctgatgagattgtagcagatagcttcgaggccttaggggctaataccattaaagaacctggtctttgcccatctgtgtcttctaatgaccaacaagtaccttcggctgttcgttacaacgggtcaaagagagtgaaacctgaggaagaagaagagagagacatgaagaaatctaggggattcgatgaaagggagttgttttcgactgctgaatcttcttcttcttcgagtgtgtttttcgtttcgcagtcttgctcgttggcatcagaagggaagaatctggaaggtattcaagattcatctgatcagattactacaagtttgggaaaaaatggttgcaaaggatcctaa

SEQ ID NO: 27 - DNA, 1509 bp, synthetic construct
  source 1..1509: mol_type = other DNA
atggataaagcggaattaattcccgagcctccaaaaaagaagagaaaggtcgaattgggtaccgccgccaattttaatcaaagtgggaatattgctgatagctcattgtccttcactttcactaacagtagcaacggtccgaacctcataacaactcaaacaaattctcaagcgctttcacaaccaattgcctcctctaacgttcatgataacttcatgaataatgaaatcacggctagtaaaattgatgatggtaataattcaaaaccactgtcacctggttggacggaccaaactgcgtataacgcgtttggaatcactacagggatgtttaataccactacaatggatgatgtatataactatctattcgatgatgaagataccccaccaaacccaaaaaaagagatctttaatacgactcactatagggcgagcgccgaagctagcgccaccatgaatggagctataggaggtgaccttttgctcaattttcctgacatgtcggtcctagagcgccaaagggctcacctcaagtacctcaatcccacctttgattctcctctcgccggcttctttgccgattcttcaatgattaccggcggcgagatggacagctatctttcgactgccggtttgaatcttccgatgatgtacggtgagacaacggtggaaggtgattcaagactctcaatttcgccggaaacgacgcttgggactggaaatttcaagaaacggaagtttgatacagagactaaggattgtaatgagaagaagaagaagatgacgatgaacagagatgacctagtagaagaaggagaagaagagaagtcgaaaataacagagcaaaacaatgggagcacaaaaagcatcaagaagatgaaacacaaagccaagaaagaagagaacaatttctctaatgattcatctaaagtgacgaaggaattggagaaaacggattatattcatgttcgtgcacgacgaggccaagccactgatagtcacagcatagcagaacgagttagaagagaaaagatcagtgagagaatgaagtttctacaagatttggttcctggatgcgacaagatcacaggcaaagcagggatgcttgatgaaatcattaactatgttcagtctcttcagagacaaatcgagttcttatcgatgaaactagcaattgtgaatccaaggccggattttgatatggatgacatttttgccaaagaggttgcctcaactccaatgactgtggtgccatctcctgaaatggttctttccggttattctcatgagatggttcactctggttattctagtgagatggttaactccggttaccttcatgtcaatccaatgcagcaagtgaataccagttctgatccattgtcatgcttcaacaatggcgaagctccttcgatgtgggactctcatgtgcagaatctctatggcaatttaggagtaccggtcatcgagctcgagctgcagatgaatcgtagatacggatcctaa

SEQ ID NO: 28 - DNA, 951 bp, synthetic construct
  source 1..951: mol_type = other DNA
atgaagctactgtcttctatcgaacaagcatgcgatatttgccgacttaaaaagctcaagtgctccaaagaaaaaccgaagtgcgccaagtgtctgaagaacaactgggagtgtcgctactctcccaaaaccaaaaggtcaccgctgactagggcacatctgacagaagtggaatcaaggctagaaagactggaacagctatttctactgatttttcctcgagaagaccttgacatgattttgaaaatggattctttacaggatataaaagcattgttaacaggattatttgtacaagataatgtgaataaagatgccgtcacagatagattggcttcagtggagactgatatgcctctaacattgagacagcatagaataagtgcgacatcatcatcggaagagagtagtaacaaaggtcaaagacagttgactgtatcgggttctggaggcggaggctccggtggtggtggaagtggcggtggcggatccatgggacacactctttacgcccctggaggatacgacattatgggatatttggatcagattgcgaaccgcccaaaccctcaggtcgaactggggcctgtggacctgtcatgtgccctgatcctgtgcgatctgaagcaaaaggacactccgatcgtctacgcctcggaagccttcttggagatgaccggatacaacagacatgaggtgctcggcaggaactgcagattcctgcagtcccccgacgggatggtgaaaccaaagtcgactcgcaaatatgtggactcgaacacgatctacaccatcaagaaggccatcgaccggaacgccgaggtccaggtggaggtggtcaactttaagaagaacggccagcggttcgtgaactttctgaccatcattccggtccgggatgaaaccggagagtacagatactccatcggattccagtgcgaaaccgaataa

SEQ ID NO: 29 - DNA, 1005 bp, synthetic construct
  source 1..1005: mol_type = other DNA
atgggacataccctctacgcgccggggggttatgacatcatgggttacctcagacagatcagaaaccggccgaacccacaagtggagctgggacccgtcgacctctcctgcgccctcgtgctgtgtgaccttaagcagaaggacacccctgtggtgtacgcctccgaagcattcctggagatgaccgggtacaacagacacgaagtgctgggacggaactgccgcttcctgcaatccccggatggaatggtgaagcctaagtcaacccgcaaatacgtggactccaacactatctacaccatgaagaaggccattgaccgcaatgctgaggtgcaagtggaagtggtgaacttcaagaagaacggacagcgcttcgtcaacttcctgactatgattcccgtgcgggacgaaaccggcgaataccggtacagcatcgggtttcagtgcgagactgagggcggtggcggcagtggtggaatgaagcaactcgaggacaaggttgaggaactgctgagtaagaattaccacctcgaaaacgaggtcgcacgattgaaaaagttggtgggtgagggaggtggtggatcgggtggaggttctgataaagcggaattaattcccgagcctccaaaaaagaagagaaaggtcgaattgggtaccgccgccaattttaatcaaagtgggaatattgctgatagctcattgtccttcactttcactaacagtagcaacggtccgaacctcataacaactcaaacaaattctcaagcgctttcacaaccaattgcctcctctaacgttcatgataacttcatgaataatgaaatcacggctagtaaaattgatgatggtaataattcaaaaccactgtcacctggttggacggaccaaactgcgtataacgcgtttggaatcactacagggatgtttaataccactacaatggatgatgtatataactatctattcgatgatgaagataccccaccaaacccaaaaaaagagtaa

SEQ ID NO: 30 - DNA, 951 bp, synthetic construct
  source 1..951: mol_type = other DNA
atgaagctactgtcttctatcgaacaagcatgcgatatttgccgacttaaaaagctcaagtgctccaaagaaaaaccgaagtgcgccaagtgtctgaagaacaactgggagtgtcgctactctcccaaaaccaaaaggtcaccgctgactagggcacatctgacagaagtggaatcaaggctagaaagactggaacagctatttctactgatttttcctcgagaagaccttgacatgattttgaaaatggattctttacaggatataaaagcattgttaacaggattatttgtacaagataatgtgaataaagatgccgtcacagatagattggcttcagtggagactgatatgcctctaacattgagacagcatagaataagtgcgacatcatcatcggaagagagtagtaacaaaggtcaaagacagttgactgtatcgggttctggaggcggaggctccggtggtggtggaagtggcggtggcggatccatgggacacactctttacgcccctggaggatacgacattatgggatatttggatcagattgcgaaccgcccaaaccctcaggtcgaactggggcctgtggacctgtcatgtgccctgatcctgtgcgatctgaagcaaaaggacactccgatcgtctacgcctcggaagccttcttggagatgaccggatacaacagacatgaggtgctcggcaggaactgcagattcctgcagtcccccgacgggatggtgaaaccaaagtcgactcgcaaatatgtggactcgaacacgatcttcaccatcaagaaggccatcgaccggaacgccgaggtccaggtggaggtggtcaactttaagaagaacggccagcggttcgtgaactttctgaccatcattccggtccgggatgaaaccggagagtacagatactccatcggattccagtgcgaaaccgaataa

SEQ ID NO: 31 - DNA, 1005 bp, synthetic construct
  source 1..1005: mol_type = other DNA
atgggacataccctctacgcgccggggggttatgacatcatgggttacctcagacagatcagaaaccggccgaacccacaagtggagctgggacccgtcgacctctcctgcgccctcgtgctgtgtgaccttaagcagaaggacacccctgtggtgtacgcctccgaagcattcctggagatgaccgggtacaacagacacgaagtgctgggacggaactgccgcttcctgcaatccccggatggaatggtgaagcctaagtcaacccgcaaatacgtggactccaacactatcttcaccatgaagaaggccattgaccgcaatgctgaggtgcaagtggaagtggtgaacttcaagaagaacggacagcgcttcgtcaacttcctgactatgattcccgtgcgggacgaaaccggcgaataccggtacagcatcgggtttcagtgcgagactgagggcggtggcggcagtggtggaatgaagcaactcgaggacaaggttgaggaactgctgagtaagaattaccacctcgaaaacgaggtcgcacgattgaaaaagttggtgggtgagggaggtggtggatcgggtggaggttctgataaagcggaattaattcccgagcctccaaaaaagaagagaaaggtcgaattgggtaccgccgccaattttaatcaaagtgggaatattgctgatagctcattgtccttcactttcactaacagtagcaacggtccgaacctcataacaactcaaacaaattctcaagcgctttcacaaccaattgcctcctctaacgttcatgataacttcatgaataatgaaatcacggctagtaaaattgatgatggtaataattcaaaaccactgtcacctggttggacggaccaaactgcgtataacgcgtttggaatcactacagggatgtttaataccactacaatggatgatgtatataactatctattcgatgatgaagataccccaccaaacccaaaaaaagagtaa

SEQ ID NO: 32 - DNA, 1005 bp, synthetic construct
  source 1..1005: mol_type = other DNA
atgggacataccctctacgcgccggggggttatgacatcatgggttacctcagacagatcagaaaccggccgaacccacaagtggagctgggacccgtcgacctctcctgcgccctcatcctgtgtgaccttaagcagaaggacacccctgtggtgtacgcctccgaagcattcctggagatgaccgggtacaacagacacgaagtgctgggacggaactgccgcttcctgcaatccccggatggaatggtgaagcctaagtcaacccgcaaatacgtggactccaacactatctacaccatgaagaaggccattgaccgcaatgctgaggtgcaagtggaagtggtgaacttcaagaagaacggacagcgcttcgtcaacttcctgactatgattcccgtgcgggacgaaaccggcgaataccggtacagcatcgggtttcagtgcgagactgagggcggtggcggcagtggtggaatgaagcaactcgaggacaaggttgaggaactgctgagtaagaattaccacctcgaaaacgaggtcgcacgattgaaaaagttggtgggtgagggaggtggtggatcgggtggaggttctgataaagcggaattaattcccgagcctccaaaaaagaagagaaaggtcgaattgggtaccgccgccaattttaatcaaagtgggaatattgctgatagctcattgtccttcactttcactaacagtagcaacggtccgaacctcataacaactcaaacaaattctcaagcgctttcacaaccaattgcctcctctaacgttcatgataacttcatgaataatgaaatcacggctagtaaaattgatgatggtaataattcaaaaccactgtcacctggttggacggaccaaactgcgtataacgcgtttggaatcactacagggatgtttaataccactacaatggatgatgtatataactatctattcgatgatgaagataccccaccaaacccaaaaaaagagtaa